(19) United States
(12) Patent Application Publication
(10) Pub. No.: US 2024/0273838 A1
(43) Pub. Date: Aug. 15, 2024

(54) SYSTEM AND METHOD OF AUGMENTED REPRESENTATION OF AN ELECTRONIC DEVICE

(71) Applicant: Apple Inc., Cupertino, CA (US)

(72) Inventors: Alexis H. PALANGIE, Palo Alto, CA (US); Benjamin HYLAK, San Francisco, CA (US); Aaron M. BURNS, Sunnyvale, CA (US); Nathan GITTER, Cupertino, CA (US)

(21) Appl. No.: 18/587,739

(22) Filed: Feb. 26, 2024

Related U.S. Application Data
(63) Continuation of application No. PCT/US2022/075482, filed on Aug. 25, 2022.
(60) Provisional application No. 63/238,030, filed on Aug. 27, 2021.

(51) Int. Cl. G06T 19/00

(52) U.S. Cl. CPC G06T 19/006; G06T 2200/24

(57) ABSTRACT

Some embodiments of the disclosure are directed to an augmented representation of a first electronic device. A three-dimensional representation of a first electronic device (e.g., an augmented device) is presented using a second electronic device in a three-dimensional environment. The three-dimensional environment includes captured portions of a real-world environment, optionally including the first electronic device. The augmented representation of the first electronic device includes a virtual user interface element representing an extension of the physical display of the first electronic device. The representation of the augmented device includes a display of the augmented user interface. The augmented device is optionally configured to display some or all of the user interfaces operating on the first electronic device. Manipulations of and/or interactions with the augmented representation of the first electronic device are possible.

### CROSS-REFERENCE TO RELATED APPLICATIONS

This application is a continuation of International Application No. PCT/US2022/075482, filed Aug. 25, 2022, which claims the benefit of U.S. Provisional Application No. 63/238,030, filed Aug. 27, 2021, the contents of which are herein incorporated by reference in their entireties for all purposes.

### FIELD OF THE DISCLOSURE

This relates generally to systems and methods of augmented electronic devices.

### BACKGROUND OF THE DISCLOSURE

Many types of computing system are available, such as a mobile phone, a tablet, a touchpad, a portable or desktop computer, a portable media player, and a wearable device. Computing systems may include a display or a touch screen to enable user interactions. However, these computing systems are limited by the physical constraints of the display or touch screen.

### SUMMARY OF THE DISCLOSURE

Some embodiments of the disclosure are directed to an augmented representation of a first electronic device. In some embodiments, a three-dimensional representation of a first electronic device (e.g., an augmented device) is presented using a second electronic device in a three-dimensional environment (e.g., in a computer-generated environment). In some embodiments, the three-dimensional environment includes captured portions of a real-world environment, optionally including the first electronic device. In some embodiments, the augmented representation of the first electronic device includes presenting a representation of the display of the first electronic device with a different characteristic (e.g., an expanded size). In some embodiments, the augmented representation of the first electronic device includes presenting virtual user interface element (e.g., a window, pane, container, etc.) representing an extension of the display of the first electronic device. In some embodiments, the virtual user interface element is presented concurrently with the display of the first electronic device (or a representation of the display of the first electronic device). The representation of the augmented device includes a display of the augmented user interface (e.g., corresponding to the user interface of the first electronic device). In some embodiments, the augmented device is optionally configured to display some or all of the user interfaces operating on the first electronic device. In some embodiments, a portion of the user interfaces (e.g., a first application) can be presented in a virtual user interface element (e.g., a window) of the augmented device and a portion of the user interfaces (e.g., a second application) can be presented in a representation of the display of the first electronic device. In some embodiments, manipulations of and/or interactions are possible with the augmented representation of the first electronic device. In some embodiments, the manipulations of and/or interactions with the augmented representation of the first electronic device also impact the operation of the first electronic device. For example, launching, moving, resizing, and/or providing input to an application using the augmented representation of the first electronic device can cause the corresponding behavior to be executed on the first electronic device.

In some embodiments, in addition to presenting the augmented device, the second electronic device may concurrently present one or more additional user interfaces within the three-dimensional environment. For example, the one or more user interfaces can include one or more application windows. In some embodiments, a movement of a first virtual object of the one or more virtual objects displayed in the augmented user interface of the augmented device to a first application window of the one or more application windows within the three-dimensional environment (e.g., outside of the augmented device/augmented user interface) optionally causes a transfer of object data (e.g., file data) corresponding to the first virtual object from the first electronic device to the second electronic device. In some embodiments, a movement of a second virtual object of the one or more virtual objects presented in the first application window within the three-dimensional environment optionally causes a transfer of object data (e.g., file data) corresponding to the second virtual object from the second electronic device to the first electronic device. In other words, in addition to presenting a visual representation of an object (e.g., data representing a graphical representation of the object) in a different location, additional data can be transferred. For example, a representation icon representing a file can be presented in a new location and the contents of the file can be transferred as well (e.g., storing the file contents in memory on a different electronic device).

Some embodiments of the disclosure are directed to user-interactions with and/or manipulations of an augmented device presented within a three-dimensional environment on an electronic device. In some embodiments, the augmented device corresponds to a first electronic device in communication with one or more physical input devices (e.g., a keyboard, trackpad, etc.). The three-dimensional environment is presented using a second electronic device, the second electronic device including one or more input devices (e.g., physical input devices that require tactile input from the users and/or motion tracking devices such as accelerometers, gyroscopes, eye or finger/hand tracking devices, etc.). In some embodiments, user interactions (e.g., user input, such as touch, tap, motion/reorientation of the eyes or of the second electronic device, etc.) received at the second electronic device may cause the presentation of the augmented device and/or cause the presentation of the augmented device to be updated according to the input. In some embodiments, the augmented user interface of the augmented device includes a cursor controllable by the one or more input devices in communication with the first electronic device (e.g., a cursor controlled by a mouse or trackpad). In some embodiments, user interactions with the augmented user interface (e.g., one or more virtual user interface elements and/or one or more virtual objects) using the cursor may cause the presentation of the augmented user interface to be updated according to the cursor input. In some embodiments, the user input received at the one or more input devices in communication with the first electronic device is communicated to the second electronic device in real time (e.g., less than 50 ms delay), such that input received at both the first electronic device and the second electronic device are synchronized for interacting with the augmented device in the three-dimensional environment presented using the second electronic device (e.g., using a combination of inputs at the first electronic device and at the second electronic device).

Interacting with the augmented device in the three-dimensional environment may include movement of one or more virtual objects and resetting a position of the cursor within the augmented user interface of the augmented device. In some embodiments, a user's gaze may be tracked by the second electronic device as an input for targeting and/or selecting an object within the three-dimensional environment. For example, gaze can be used to identify one or more virtual objects using another selection input, or select a virtual object when gaze is maintained for a threshold period of time. In some embodiments, gaze can also identify a target location for movement of an object or cause a movement of one or more virtual objects following the gaze. In some embodiments, the cursor controlled by the one or more input devices in communication with the first electronic device may be used to select a first virtual object of the one or more virtual objects, and the user's gaze may be used to move the selected first virtual object within portions of the augmented device user interface. In some embodiments, the first virtual object may be moved by the gaze from the augmented user interface of the augmented device to an application window presented within the three-dimensional environment outside the augmented device user interface. In some embodiments, the first virtual object may be moved by the gaze from the application window presented within the three-dimensional environment (e.g., outside the augmented user interface) to the augmented user interface of the augmented device. In some embodiments, a user's gaze may indicate a target for selection and/or movement, and another input device (e.g., mouse button or trackpad) can be used for selection and deselection. In some such embodiments, in response to detecting a conclusion of cursor input at the one or more input devices in communication with the first electronic device (e.g., liftoff from the trackpad or releasing a mouse button, or a subsequent press of the trackpad or mouse button), the first virtual object can be released within the augmented device. In some such embodiments, if the gaze is within a threshold distance of a current location of the cursor (at the time of release), the first virtual object is presented at the current location of the cursor within the augmented user interface. In some such embodiments, in response to detecting conclusion of the cursor input, if the gaze is outside the threshold distance of the current location of the cursor, the first virtual object and the cursor are presented at a current location of the gaze within the augmented user interface (e.g., the cursor is presented at a new location and ceases to be presented at the location of the cursor at the time of release of the first virtual object.

The full descriptions of these embodiments are provided in the Drawings and the Detailed Description, and it is understood that this Summary does not limit the scope of the disclosure in any way.

### BRIEF DESCRIPTION OF THE DRAWINGS

For improved understanding of the various embodiments described herein, reference should be made to the Detailed Description below along with the following drawings. Like reference numerals often refer to corresponding parts throughout the drawings.

FIG. 1 illustrates an electronic device displaying an extended reality environment according to embodiments of the disclosure.

FIG. 2 illustrates a block diagram of an exemplary architecture for a system or device according to embodiments of the disclosure.

FIG. 3A illustrates an exemplary real-world environment including a first electronic device and one or more input devices according to some embodiments of the disclosure.

FIG. 3B illustrates an example of an extended reality environment presented to the user using a second electronic device according to embodiments of the disclosure.

FIG. 3C illustrates another example of an extended reality environment presented to the user using a second electronic device according to embodiments of the disclosure.

FIG. 3D illustrates an example augmented device corresponding to the first electronic device presented to the user using the second electronic device according to embodiments of the disclosure.

FIG. 3E illustrates an example augmented device including an extended display presented to the user using the second electronic device according to embodiments of the disclosure.

FIG. 3F illustrates example user interactions with the augmented device within the extended reality environment according to embodiments of the disclosure.

FIG. 3G illustrates an example user interaction with one or more user interface elements of the augmented device according to embodiments of the disclosure.

FIGS. 4A-4D illustrate example user interactions of moving an object from an application window running on the second electronic device to a first electronic device (e.g., an augmented device) according to embodiments of the disclosure.

FIGS. 5A-5D illustrate example user interactions of moving an object from an application window running on the second electronic device to the augmented device including a cursor, according to embodiments of the disclosure.

FIGS. 6A-6D illustrate example user interactions of moving an object from the augmented device to an application window running on the second electronic device using the cursor according to embodiments of the disclosure.

FIGS. 7A-7B illustrate example user interactions of moving a cursor between the augmented user interfaces of the augmented device when the augmented device includes an extended display according to embodiments of the disclosure.

FIGS. 8A-8D illustrate flow diagrams illustrating example processes for presenting an augmented device corresponding to an electronic device according to embodiments of the disclosure.

FIGS. 9A-9C illustrate flow diagrams illustrating example processes for moving an object between an augmented device corresponding to a first electronic device and an application window running on a second electronic device according to embodiments of the disclosure.

FIGS. 10A-10C illustrate flow diagrams illustrating example processes for altering a position of a cursor within an augmented device corresponding to a first electronic device while moving an object between the augmented device and an application window running on a second electronic device according to embodiments of the disclosure.

### DETAILED DESCRIPTION

Some embodiments of the disclosure are directed to an augmented representation of a first electronic device. In some embodiments, a three-dimensional representation of a first electronic device (e.g., an augmented device) is presented using a second electronic device in a three-dimensional environment (e.g., in a computer-generated environment). In some embodiments, the three-dimensional environment includes captured portions of a real-world environment, optionally including the first electronic device. In some embodiments, the augmented representation of the first electronic device includes a representation of the display of the first electronic device with a different characteristic (e.g., an expanded size). In some embodiments, the augmented representation of the first electronic device includes a virtual user interface element (e.g., a window, pane, container, etc.) representing an extension of the display of the first electronic device. In some embodiments, the virtual user interface element is presented concurrently with the display of the first electronic device (or a representation of the display of the first electronic device). In some embodiments, the representation of the augmented device includes an augmented user interface (e.g., corresponding to the user interface of the first electronic device). In some embodiments, the augmented device is optionally configured to display some or all of the user interfaces operating on the first electronic device. In some embodiments, a portion of the user interfaces (e.g., a first application) can be presented in a virtual user interface element (e.g., a window) of the augmented device and a portion of the user interfaces (e.g., a second application) can be presented in a representation of the display of the first electronic device. In some embodiments, manipulations of and/or interactions with the augmented representation of the first electronic device are possible. In some embodiments, the manipulations of and/or interactions with the augmented representation of the first electronic device also impact the operation of the first electronic device. For example, launching, moving, resizing, and/or providing input to an application using the augmented representation of the first electronic device can cause the corresponding behavior to be executed on the first electronic device.

In some embodiments, in addition to presenting the augmented device, the second electronic device may concurrently present one or more additional user interfaces within the three-dimensional environment. For example, the one or more user interfaces can include one or more application windows. In some embodiments, a movement of a first virtual object of the one or more virtual objects displayed in the augmented user interface of the augmented device to a first application window of the one or more application windows within the three-dimensional environment (e.g., outside of the augmented device/augmented user interface) optionally causes a transfer of object data (e.g., file data) corresponding to the first virtual object from the first electronic device to the second electronic device. In some embodiments, a movement of a second virtual object of the one or more virtual objects presented in the first application window within the three-dimensional environment to the augmented user interface of the augmented device optionally causes a transfer of object data (e.g., file data) corresponding to the second virtual object from the second electronic device to the first electronic device. In other words, in addition to presenting a visual representation of an object (e.g., data representing a graphical representation of the object) in a different location, additional data can be transferred. For example, an icon representing a file can be presented in a new location and the contents of the file can be transferred as well (e.g., storing the file contents in memory on a different electronic device).

Some embodiments of the disclosure are directed to user-interactions with and/or manipulations of an augmented device presented within a three-dimensional environment on an electronic device. In some embodiments, the augmented device corresponds to a first electronic device in communication with one or more physical input devices (e.g., a keyboard, trackpad, etc.). The three-dimensional environment is presented using a second electronic device, the second electronic device including one or more input devices (e.g., physical input devices that require tactile input from the users and/or motion tracking devices such as accelerometers, gyroscopes, eye or finger/hand tracking devices, etc.). In some embodiments, user interactions (e.g., user input, such as touch, tap, motion/reorientation of the eyes or of the second electronic device, etc.) received at the second electronic device may cause the presentation of the augmented device to be generated and/or updated according to the input. In some embodiments, the augmented user interface of the augmented device includes a cursor controllable by the physical or other input device in communication with the first electronic device (e.g., a cursor controlled by a mouse or trackpad). In some embodiments, user interactions with the augmented user interface (e.g., one or more virtual user interface elements and/or one or more virtual objects) using the cursor may cause the presentation of the augmented user interface to be updated according to the cursor input. In some embodiments, the user input received at the physical or other input device in communication with the first electronic device is communicated to the second electronic device in real time (e.g., less than 50 ms delay), such that input received at both the first electronic device and the second electronic device are synchronized for interacting with the augmented device in the three-dimensional environment presented using the second electronic device (e.g., using a combination of inputs at the first electronic device and at the second electronic device).

Interacting with the augmented device in the three-dimensional environment may include movement of one or more virtual objects and resetting a position of the cursor within the augmented user interface of the augmented device. In some embodiments, a user's gaze may be tracked by the second electronic device as an input for targeting and/or selecting an object within the three-dimensional environment. For example, gaze can be used to identify one or more virtual objects using another selection input, or select a virtual object when gaze is maintained for a threshold period of time. In some embodiments, gaze can also identify a target location for movement of an object or cause a movement of one or more virtual objects following the gaze. In some embodiments, the cursor controlled by the physical or other input device in communication with the first electronic device may be used to select a first virtual object of the one or more virtual objects, and the user's gaze may be used to move the selected first virtual object within portions of the augmented device user interface. In some embodiments, the first virtual object may be moved by the gaze from the augmented user interface of the augmented device to an application window presented within the three-dimensional environment outside the augmented device user interface. In some embodiments, the first virtual object may be moved by the gaze from the application window presented within the three-dimensional environment (e.g., outside the augmented user interface) to the augmented user interface of the augmented device. In some embodiments, a user's gaze may indicate a target for selection and/or movement, and another input device (e.g., mouse button or trackpad) can be used for selection and deselection. In some such embodiments, in response to detecting a conclusion of cursor input at the physical or other input device in communication with the first electronic device (e.g., liftoff from the trackpad or releasing a mouse button, or a subsequent press of the trackpad or mouse button), the first virtual object can be released within the augmented device. In some such embodiments, if the gaze is within a threshold distance of a current location of the cursor (at the time of release), the first virtual object is presented at the current location of the cursor within the augmented user interface. In some such embodiments, in response to detecting conclusion of the cursor input, if the gaze is outside the threshold distance of the current location of the cursor, the first virtual object and the cursor are presented at a current location of the gaze within the augmented user interface (e.g., the cursor is presented at a new location and ceases to be presented at the location of the cursor at the time of release of the first virtual object.

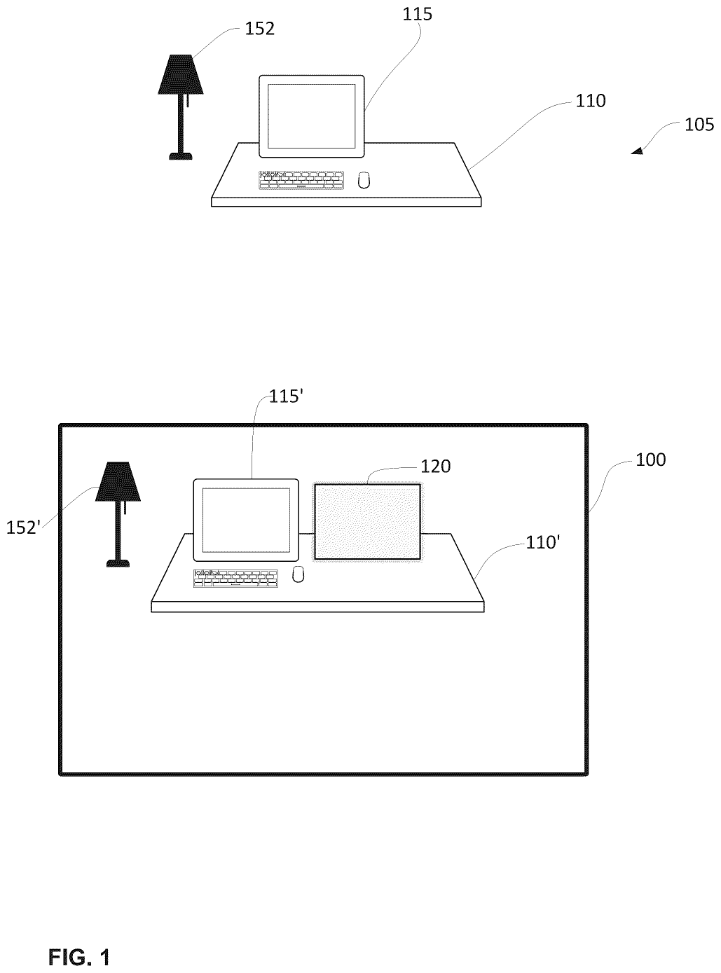

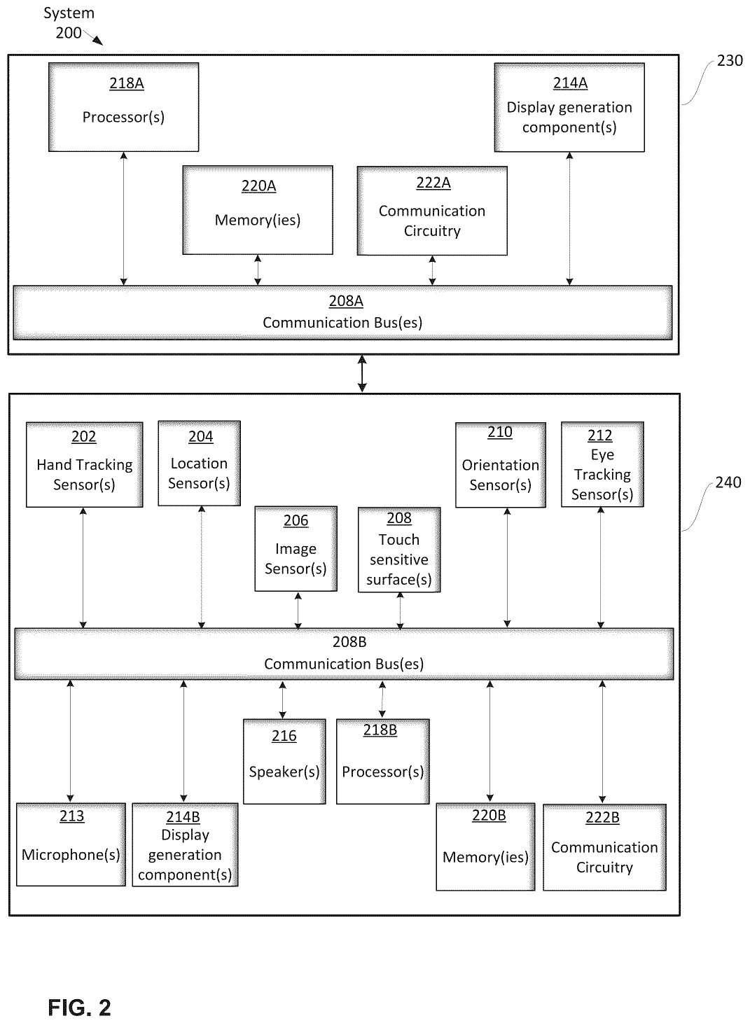

FIG. 1 illustrates an electronic device 100 displaying an extended reality (XR) environment (e.g., a computer-generated environment) according to embodiments of the disclosure. In some embodiments, electronic device 100 is a hand-held or mobile device, such as a tablet computer, laptop computer, smartphone, or head-mounted display. Additional examples of device 100 are described below with reference to the architecture block diagram of FIG. 2. As shown in FIG. 1, electronic device 100 and tabletop 110 are located in the physical environment 105. The physical environment may include physical features such as a physical surface (e.g., floor, walls) or a physical object (e.g., table, lamp, etc.). In some embodiments, electronic device 100 may be configured to capture areas of physical environment 105 including tabletop 110, lamp 152, desktop computer 115 and input devices 116 (illustrated in the field of view of electronic device 100). In some embodiments, in response to a trigger, the electronic device 100 may be configured to display a virtual object 120 in the computer-generated environment (e.g., represented by an application window illustrated in FIG. 1) that is not present in the physical environment 105, but is displayed in the computer-generated environment positioned on (e.g., anchored to) the top of a computer-generated representation 110′ of real-world table top 110. For example, virtual object 120 can be displayed on the surface of the tabletop 110′ in the computer-generated environment displayed via device 100 in response to detecting the planar surface of tabletop 110 in the physical environment 105.

It should be understood that virtual object 120 is a representative virtual object and one or more different virtual objects (e.g., of various dimensionality such as two-dimensional or three-dimensional virtual objects) can be included and rendered in a three-dimensional computer-generated environment. For example, the virtual object can represent an application or a user interface displayed in the computer-generated environment. In some embodiments, the virtual object 120 is optionally configured to be interactive and responsive to user input, such that a user may virtually touch, tap, move, rotate, or otherwise interact with, the virtual object. Additionally, it should be understood that, as used herein, the three-dimensional (3D) environment (or 3D virtual object) may be a representation of a 3D environment (or three-dimensional virtual object) projected or presented at an electronic device.

In the discussion that follows, an electronic device that is in communication with a display generation component and one or more input devices is described. It should be understood that the electronic device optionally is in communication with one or more other physical user-interface devices, such as touch-sensitive surface, a physical keyboard, a mouse, a joystick, a hand tracking device, an eye tracking device, a stylus, etc. Further, as described above, it should be understood that the described electronic device, display and/or touch-sensitive surface are optionally distributed amongst two or more devices. Therefore, as used herein, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

In some embodiments, the electronic device supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an exemplary architecture for a system or device 220 according to embodiments of the disclosure. In some embodiments, device 200 is a mobile device, such as a mobile phone (e.g., smart phone), a tablet computer, a laptop computer, a desktop computer, a head-mounted display, an auxiliary device in communication with another device, etc. In some embodiments, device 200 includes various sensors (e.g., one or more hand tracking sensor(s), one or more location sensor(s), one or more image sensor(s), one or more touch-sensitive surface(s), one or more motion and/or orientation sensor(s), one or more eye tracking sensor(s), one or more microphone(s) or other audio sensors, etc.), one or more display generation component(s), one or more speaker(s), one or more processor(s), one or more memories, and/or communication circuitry. One or more communication buses are optionally used for communication between the above-mentioned components of device 200.

In some embodiments, as illustrated in FIG. 2, system/device 200 can be divided between multiple devices. For example, a first device 230 optionally includes processor(s) 218A, memory or memories 220A, communication circuitry 222A, and display generation component(s) 214A optionally communicating over communication bus(es) 208A. A second device 240 (e.g., corresponding to device 200) optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214B, one or more speaker(s) 216, one or more processor(s) 218B, one or more memories 220B, and/or communication circuitry 222B. One or more communication buses 208B are optionally used for communication between the above-mentioned components of device 240. In some embodiments, first device 230 and second device 240 communicate via a wired or wireless connection (e.g., via communication circuitry 222A-222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B may include one or more general processors, one or more graphics processors, and/or one or more digital signal processors. In some embodiments, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some embodiments, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. For example, the non-transitory computer-readable storage medium can include, but is not limited to, magnetic, optical, and/or semiconductor storages. In some embodiments, such storage may include magnetic disks, optical discs based on CD, DVD, or Blu-ray technologies, as well as persistent solid-state memory such as flash, solid-state drives, and the like.

In some embodiments, display generation component(s) 214A, 214B include a single display (e.g., a liquid-crystal display (LCD), organic light-emitting diode (OLED), or other types of display). In some embodiments, display generation component(s) 214A, 214B includes multiple displays. In some embodiments, display generation component(s) 214A, 214B can include a display with touch capability (e.g., a touch screen), a projector, a holographic projector, a retinal projector, etc. In some embodiments, device 240 includes touch-sensitive surface(s) 209 for receiving user inputs, such as tap inputs and swipe inputs or other gestures. In some embodiments, display generation component(s) 214B and touch-sensitive surface(s) 209 form touch-sensitive display(s) (e.g., a touch screen integrated with device 240 or external to device 240 that is in communication with device 240).

Device 240 optionally includes image sensor(s) 206. In some embodiments, image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from device 240. In some embodiments, information from one or more depth sensors can allow the device to identify and differentiate objects in the real-world environment from other objects in the real-world environment. In some embodiments, one or more depth sensors can allow the device to determine the texture and/or topography of objects in the real-world environment.

In some embodiments, device 240 uses CCD sensors, event cameras, and depth sensors in combination to detect the physical environment around device 240. In some embodiments, image sensor(s) 206 include a first image sensor and a second image sensor. The first image sensor and the second image sensor work in tandem and are optionally configured to capture different information of physical objects in the real-world environment. In some embodiments, the first image sensor is a visible light image sensor, and the second image sensor is a depth sensor. In some embodiments, device 240 uses image sensor(s) 206 to detect the position and orientation of device 240 and/or display generation component(s) 214 in the real-world environment. For example, device 240 uses image sensor(s) 206 to track the position and orientation of display generation component(s) 214B relative to one or more fixed objects in the real-world environment.

In some embodiments, device 240 includes microphone(s) 213 or other audio sensors. Device 240 uses microphone(s) 213 to detect sound from the user and/or the real-world environment of the user. In some embodiments, microphone(s) 213 includes an array of microphones (a plurality of microphones) that optionally operate in tandem, such as to identify ambient noise or to locate the source of sound in space of the real-world environment.

Device 240 includes hand tracking sensor(s) 202 and/or eye tracking sensor(s) 212, in some embodiments. Hand tracking sensor(s) 202 are configured to track the position/location of one or more portions of the user's hands, and/or motions of one or more portions of the user's hands with respect to the extended reality environment, relative to the display generation component(s) 214B, and/or relative to another defined coordinate system. In some embodiments, eye tracking sensor(s) 212 are configured to track the position and movement of a user's gaze (eyes, face, or head, more generally) with respect to the real-world or extended reality environment and/or relative to the display generation component(s) 214B. In some embodiments, hand tracking sensor(s) 202 and/or eye tracking sensor(s) 212 are implemented together with the display generation component(s) 214B. In some embodiments, the hand tracking sensor(s) 202 and/or eye tracking sensor(s) 212 are implemented separate from the display generation component(s) 214B.

In some embodiments, the hand tracking sensor(s) 202 can use image sensor(s) 206 (e.g., one or more IR cameras, 3D cameras, depth cameras, etc.) that capture three-dimensional information from the real-world including one or more hands (e.g., of a human user). In some embodiments, the hands can be resolved with sufficient resolution to distinguish fingers and their respective positions. In some embodiments, one or more image sensor(s) 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., for detecting gestures, touch, tap, etc.) can be advantageous in that it does not require the user to touch, hold or wear any sort of beacon, sensor, or other marker.

In some embodiments, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some embodiments, both eyes are tracked separately by respective eye tracking cameras and illumination sources, and a focus/gaze can be determined from tracking both eyes. In some embodiments, one eye (e.g., a dominant eye) is tracked by a respective eye tracking camera/illumination source(s).

Device 240 includes location sensor(s) 204 for detecting a location of device 240 and/or display generation component(s) 214B. For example, location sensor(s) 204 can include a GPS receiver that receives data from one or more satellites and allows device 240 to determine the device's absolute position in the physical world.

Device 240 includes orientation sensor(s) 210 for detecting orientation and/or movement of device 240 and/or display generation component(s) 214B. For example, device 240 uses orientation sensor(s) 210 to track changes in the position and/or orientation of device 240 and/or display generation component(s) 214B, such as with respect to physical objects in the real-world environment. Orientation sensor(s) 210 optionally include one or more gyroscopes and/or one or more accelerometers.

It should be understood that system/device 200 is not limited to the components and configuration of FIG. 2, but can include fewer, alternative, or additional components in multiple configurations. In some embodiments, system 200 can be implemented in a single device. A person using system 200, is optionally referred to herein as a user of the device. Attention is now directed towards exemplary concurrent displays of a two-dimensional representation of content items and corresponding three-dimensional previews of the content items. As discussed below, the two-dimensional representation of the content items can be displayed on a first electronic device (e.g., via a content creation application) and the three-dimensional previews of the content items can be concurrently displayed at a second electronic device (e.g., via a three-dimensional graphic rendering application). In some embodiments, the processes of generating the three-dimensional preview of the content items described below can be performed by processors 218A, 218B of the devices 230 and 240.

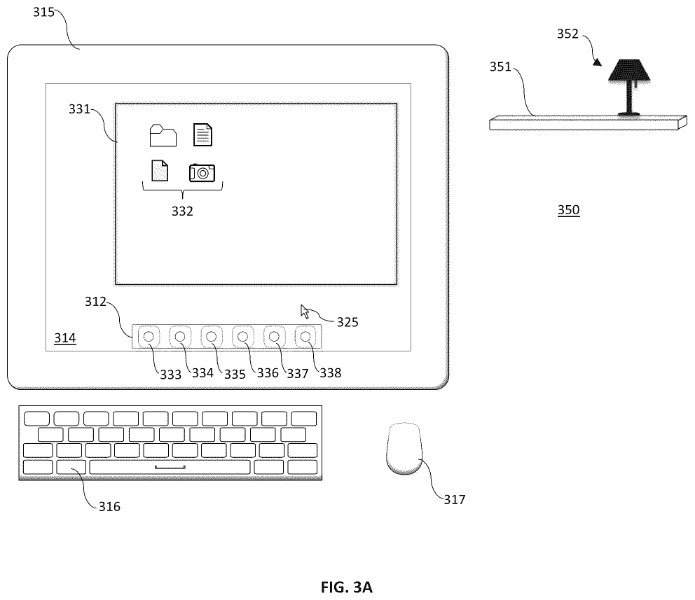

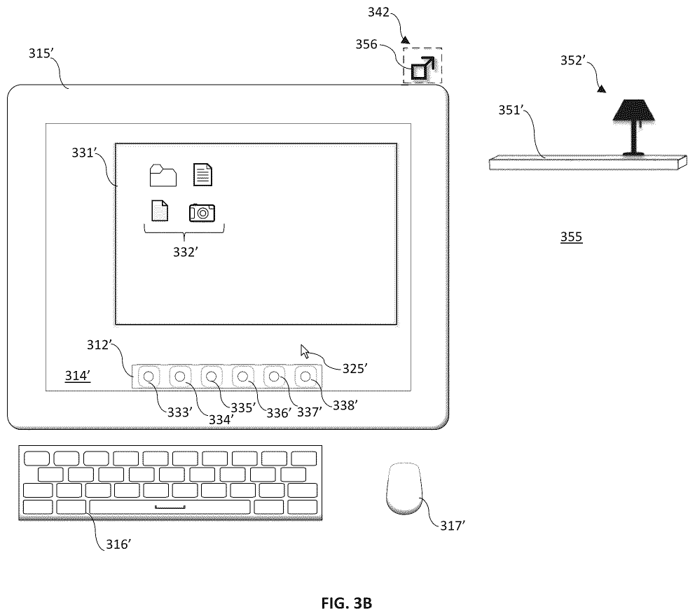

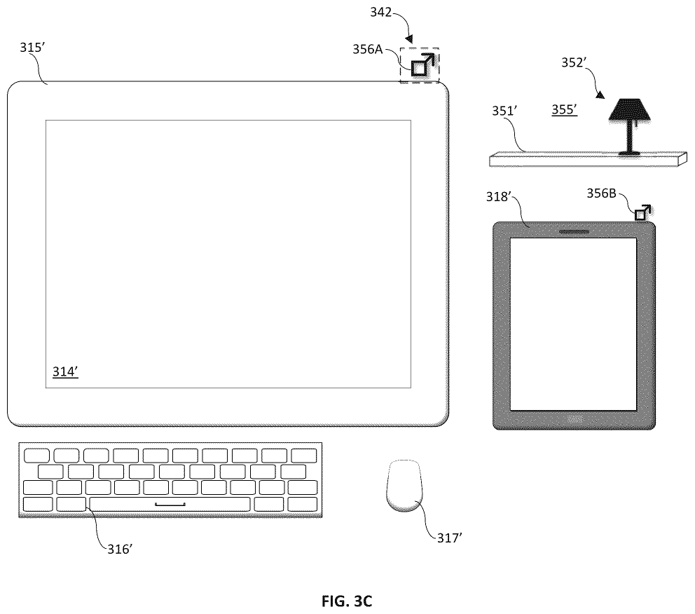

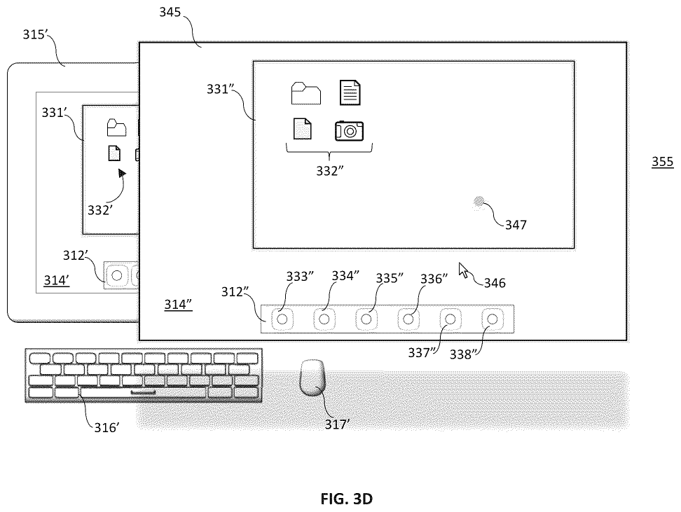

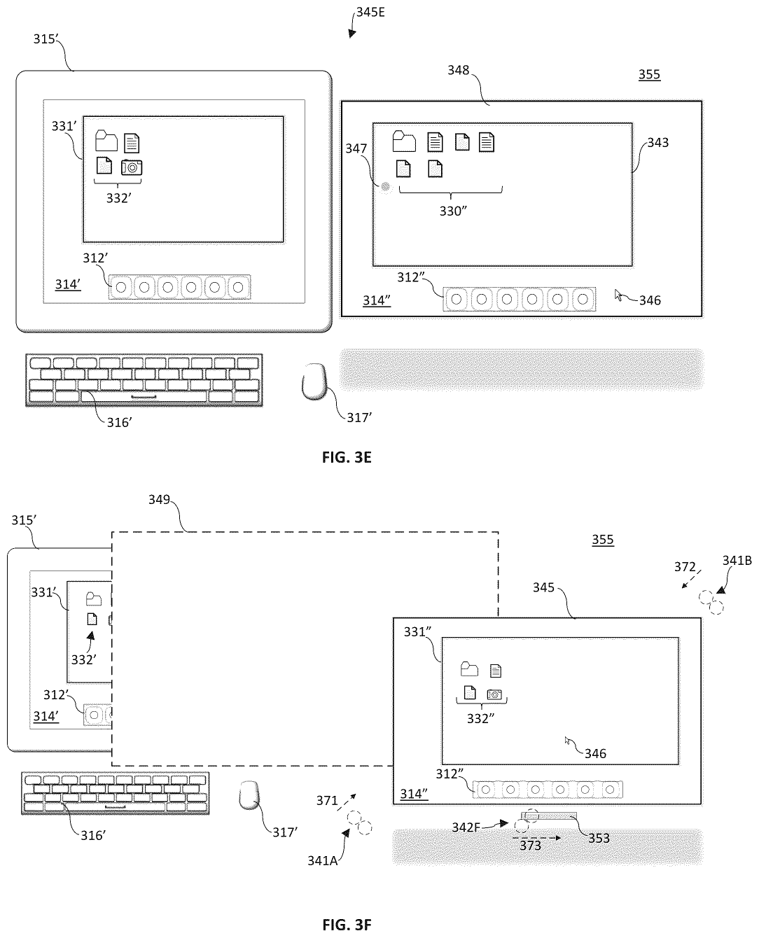

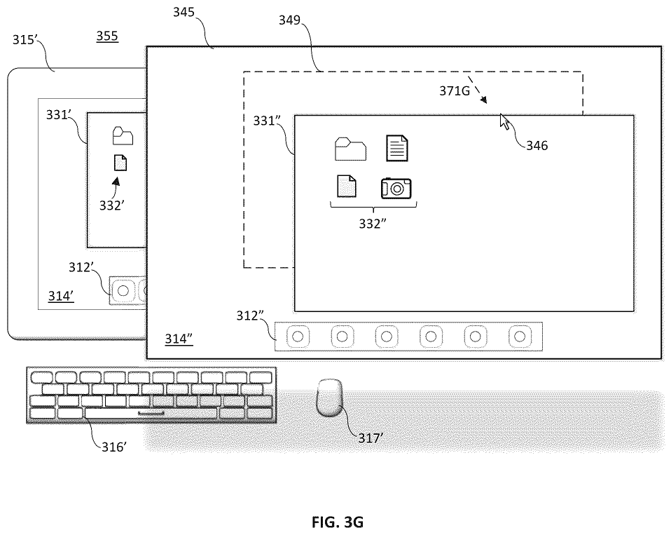

FIG. 3A illustrates an exemplary real-world environment 350 including a first electronic device 315, a first input device 316, and a second input device 317 according to some embodiments of the disclosure. The first electronic device 315 may be similar to device 100 or 230, and/or may be a tablet computing device, laptop computing device or desktop computing device, among other possible computing devices. FIG. 3A illustrates a real-world environment (e.g., a room) 350 including shelf 351 and lamp 352 disposed in a rear portion of the real-world environment 350, for example. In some embodiments, the electronic device 315 displays user interface 314 (e.g., displayed via display generation component 214A in FIG. 2). For example, the user interface 314 optionally includes a home screen (e.g., background desktop), one or more file or application windows 331, and/or one or more applications or files (e.g., represented by file or application icons or objects 332 and/or by icons 333-338 in dock 312) that are optionally running or configured to be run on the electronic device 315. As shown in the example of FIG. 3A, the application window 331 may be a folder holding one or more files/applications represented by objects 332, for example. It should be understood that the user interface elements (e.g., objects 332, icons 333-338 and/or application window 331) of FIG. 3A are merely representative, and that additional, fewer, or different user interface elements may be included within user interface 314. Additionally, the user interface elements may include additional or alternative visual characteristics (e.g., different shapes, objects, symbols, text, number and the like). For example, the application window 331 may represent any window corresponding to an application running on the electronic device 315 (e.g., a file manager application, a web browser application, a content creation application, a file viewer application, etc.) and configured to be displayed on the user interface 314. Additionally or alternatively, for example, the objects 332 and/or icons 333-338 may represent any object corresponding to data (e.g., data files, shortcuts, hyperlinks, images, photographs, etc.) stored on the electronic device 315 (e.g., stored in memory or memories 220A in FIG. 2).

In some embodiments, the first input device 316 and the second input device 317 are in communication with the electronic device 315. For example, the first input device 316 may be a wireless or wired keyboard and the second input device 317 may be a wireless or wired mouse, touchpad, etc., optionally configured to control a cursor 325 displayed within the user interface 314 of the electronic device 315 and/or selection by the cursor or another targeting mechanism. It should be understood that the input devices 316 and 317 of FIG. 3A are merely representative, and that additional, fewer, or different input devices may be in communication with the electronic device 315. In some embodiments, the first and the second input devices 316 and 317 may be integral to the first electronic device 315 (e.g., the first electronic device 315 is a laptop computer including a built int keyboard and trackpad). Additionally, as discussed herein, the first electronic device 315 may communicate with additional electronic devices.

In some embodiments, the user may perform one or more interactions with the user interface 314 of the electronic device 315. For example, as shown in FIG. 3A, the user may be interacting with one or more objects 332 within the application window 331 (e.g., opening, viewing, editing, etc. one or more files, images, videos, etc. in a corresponding application). In some embodiments, a respective object of the one or more objects 332 may be a graphical data file corresponding to three-dimensional data (e.g., describing a content item targeting a three-dimensional operating system (e.g., designed for presentation in a three-dimensional graphical environment)). In some embodiments, the first electronic device 315 is in communication with a second electronic device (e.g., corresponding to device 100 or 240) that is configured to generate and present a three-dimensional environment (e.g., an extended reality environment via a three-dimensional graphical rendering application (not shown) running on the second electronic device).

In some embodiments, it may be advantageous to provide a fully functional working environment in three-dimensions representative of interactions with the first electronic device in the real-world environment. Accordingly, providing an augmented representation of the user interface of the first electronic device in the three-dimensional may be particularly useful for interactions with the user interface of the first electronic device without the constraints of physical display of the first electronic device. For example, as described herein, the augmented device or augmented representation of the user interface of a device can provide for changing the size of the user interface beyond the dimensions of the physical display of the electronic device (e.g., enlarging the user interface or providing multiple regions for display of the user interface beyond the region corresponding to the display of the first electronic device). In some embodiments, it may be advantageous to present one or more objects (e.g., objects corresponding to three-dimensional graphical data) of the first electronic device 315 in three-dimensions. For example, two-dimensional content can be viewed or edited in three-dimensions, whereas the display of the first electronic device is limited to two-dimensions. For example, a user creating content for display in a three-dimensional environment may view the content in three-dimensions. In some embodiments, it may be advantageous to transfer data (e.g., move or copy one or more objects/data files) between the first electronic device 315 and the second electronic device, as described herein in more detail.

FIG. 3B illustrates an example of an extended reality environment 355 presented to the user using a second electronic device (e.g., corresponding to electronic device 240 in FIG. 2) according to embodiments of the disclosure. As mentioned above, the first electronic device (e.g., first electronic device 315 in FIG. 3A) may communicate with the second electronic device. The first electronic device may communicate with the second electronic device via any suitable communication means, such as, for example, wire or cable transfer (e.g., universal serial bus), wireless transfer (e.g., Wi-Fi or Bluetooth®), etc., forming a communication channel. The second electronic device may refer to a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses). In the example of FIG. 3B, the user is optionally wearing the second electronic device, such that the three-dimensional environment can be defined by X, Y and Z axes as viewed from a perspective of the second electronic device (e.g., a viewpoint associated with the second electronic device, which may be a head-mounted display, for example).

As shown in FIG. 3B, the three-dimensional computer-generated environment 355 can include a first electronic device 315 displaying the user interface 314 of FIG. 3A (or a representation of the first electronic device 315′ and/or the user interface 314′ of the first electronic device 315). The three-dimensional environment 355 may also include the user interface elements of the user interface 314 or a representation of the user interface elements of user interface 314 (e.g., optionally including representations of icons 333′-338′, dock 312′, application window 331′, objects 332′, and/or cursor 325′). Additionally or alternatively, the three-dimensional environment 355 includes the first and second input devices 316 and 317 (or a representation of the first and second input devices 316′ and 317′). Although not shown in FIGS. 3A-3B, the first electronic device and the one or more input devices may be resting on a table (or a representation of the table) that can be presented in the environment. Additionally or alternatively, the three-dimensional environment 355 includes portions of the real-world environment 350 including a shelf 351 and a lamp 352 or representations of the shelf 351′ and the lamp 352′. As used herein, particularly with reference to figures illustrating three-dimensional environments (e.g., FIGS. 3B-7B), references to three-dimensional representations of physical devices, user interfaces, and/or physical objects (e.g., denoted using apostrophe or double apostrophe) optionally refer to the physical devices, user interfaces displayed on physical devices and/or physical objects of the real-world environment represented in the three-dimensional environment. For example, in some embodiments, the representations may be a direct view of a physical object or device presented through a transparent display and/or a view of the physical object or device displayed using pass-through images or video.

In some embodiments, the three-dimensional environment 355 includes a first affordance 356. In some embodiments, the first affordance 356 may be presented in proximity to an edge of the display of the first electronic device 315 (e.g., within a threshold distance of the edge of the display). For example, as shown in FIG. 3B, the first affordance 356 is presented above the first electronic device 315 or representation thereof (e.g., within a threshold distance of a corner the first electronic device 315 or representation thereof). In some embodiments, the first affordance 356 may be presented at a depth within the three-dimensional environment 355 such that it appears in the same plane as the display of the first electronic device 315 or representation thereof. It should be understood that the first affordance 356 may be positioned differently within the three-dimensional environment. For example, the first affordance 356 may be presented on, near, below or in front of the first electronic device 315 or representation thereof and/or at other locations (e.g., a predefined distance away from the second electronic device) within the three-dimensional environment 355, among other possibilities.

In some embodiments, the second electronic device may be configured to present the first affordance when one or more first criteria are satisfied. In some embodiments, in response to detecting the one or more first criteria are satisfied, the second electronic device presents the first affordance in the three-dimensional environment. In some embodiments, satisfying the one or more first criteria corresponds to detecting the first electronic device 315 is in condition for displaying an augmented user interface. In some embodiments, the one or more first criteria can include a criterion that is satisfied when the first electronic device is detected by one or more sensors of the second electronic device (e.g., when the first electronic device is captured by one or more image sensors or cameras of the second electronic device). In some embodiments, the one or more first criteria include a criterion that is satisfied when the first electronic device is in communication with the second electronic device (e.g., a wired or wireless communication channel is established). In some embodiments, the one or more first criteria include a criterion that is satisfied when the first electronic device is displaying a user interface (e.g., user interface 314). In some embodiments, the one or more first criteria include a criterion that is satisfied when the first electronic device is a qualifying electronic device (e.g., some electronic devices may have capability for operating in the context of an augmented device, but other electronic devices may not). In some embodiments, the one or more first criteria include a criterion that is satisfied when the first and second electronic devices are authorized to share information (e.g., privacy settings, user information, user data, etc.). In some embodiments, some or all of the above criteria must be satisfied for the second electronic device before the first affordance is displayed.

In some embodiments, the first affordance 356 is selectable to launch an augmented representation of the first electronic device. For example, as shown in FIG. 3B, the user may select (directly or indirectly) the first affordance 356, as represented by selection 342. For example, the user's fingers/hands may be tracked using hand tracking sensors, and a direct input using the hand can actuate the first affordance (e.g., touching, tapping, or pinching and releasing). As another example, a user may target the first affordance using gaze tracked using eye tracking sensors, and a selection input using the hands (e.g., a pinch and release or other gesture) or other selection inputs can actuate the first affordance. In some embodiments, the first or second input devices 316 and 317 can be used to actuate the first affordance (e.g., clicking with mouse, keyboard shortcut, etc.).

FIG. 3C illustrates another example of an extended reality environment 355′ presented to the user using a second electronic device (e.g., corresponding to electronic device 240 in FIG. 2) according to embodiments of the disclosure. As discussed above with reference to FIG. 3B, the first affordance 356 is optionally presented within the three-dimensional environment 355 in accordance with detection of a first electronic device 315 in condition for presentation of an augmented user interface (e.g., when one or more first criteria are satisfied). In some embodiments, the second electronic device may be configured to detect more than one electronic device at a time (e.g., during one or more scans of the real-world environment 350 using image sensors 206). For example, as shown in FIG. 3C, the real-world environment optionally includes a third electronic device (e.g., corresponding to representation 318′), which may be a tablet computer, in communication with the second electronic device and/or the first electronic device 315. Accordingly, the three-dimensional environment 355 includes presenting the third electronic device (or displaying the representation of the third electronic device 318′), for example. In some embodiments, the third electronic device is optionally functioning as a secondary display for the first electronic device 315. In some embodiments, the third electronic device is optionally a third input device for the first electronic device 315.

In some embodiments, as shown in the example of FIG. 3C, when the one or more first criteria are satisfied for the first electronic device 315, the first affordance 356A is displayed for the first electronic device as described with reference to FIG. 3B. In some embodiments, as shown in the example of FIG. 3C, when one or more second criteria are satisfied for the third electronic device, the second affordance 356B is displayed for the third electronic device. It should be understood that, in some embodiments, the first criteria and the second criteria may be the same. As shown in FIG. 3C, the representation of the first electronic device 315′ and the representation of the third electronic device 318′ are presented with affordances 356A and 356B that are selectable (using direct or indirect selection) to launch augmented devices having user interfaces corresponding to those of the first electronic device 315 and the third electronic device, respectively, within the three-dimensional environment 355. In some embodiments, when the third electronic device functions as an extended display for the first electronic device 315, selection of the affordance 356A or 356B launches the augmented representations of both the first electronic device 315 and the third electronic device.

Although FIGS. 3B-3C illustrate electronic devices with visible displays, it is understood that, in some embodiments, the affordance for launching an augmented device user interface can be used even without a visible display or without a user interface displayed on the display of the electronic device. In some embodiments, the display of the first electronic device may not be visible because the user of the second electronic device is viewing the first electronic device from a perspective in which the display is not visible. In some embodiments, the display of the first electronic device may not be visible because the display is occluded by another object (e.g., a laptop is closed, the screen is covered, etc.). In some embodiments, the display and/or the first electronic device may not be displaying the user interface in a given state. For example, in a low-power or off state, in a shut-off state, in sleep state, in a locked-screen state, etc., the user interface (e.g., user interface 314) of the first electronic device 315 is not visible in the real-world environment. In some embodiments, the first electronic device 315 may not include a display (e.g., a computer tower with no attached monitor). In some such embodiments, the second electronic device is optionally configured to present the first affordance for launching the augmented representation of the first electronic device 315′, despite the real-world user interface(s) of the first electronic device 315 not being visible, for example. In such some embodiments, data communicated along the communication channel between the second electronic device and the first electronic device 315 is optionally synchronized so that the second electronic device can present the user interface of the first electronic devices (e.g., whether augmented or not). In some embodiments, the second electronic device is configured to access data corresponding to (e.g., data defining/describing an appearance of) a user interface of the first electronic device (including one or more user interface elements of the user interface) and one or more objects (e.g., applications, files, images, etc.) of the first electronic device. When the user selects (e.g., directly or indirectly selects) the first affordance 356A, as represented by selection 342 in FIG. 3C, the second electronic device may utilize the data corresponding to the user interface(s) and the one or more objects to generate and present an augmented representation of the user interface of the first electronic device (e.g., optionally including a user interface that would be presented on the first electronic device in the real-world environment).

FIG. 3D illustrates an augmented device 345 (augmented representation of a first electronic device 315) corresponding to the representation of first electronic device 315′ presented to the user using the second electronic device according to embodiments of the disclosure. As discussed herein, in some embodiments, the augmented device (“augmented device,” “augmented representation of the first electronic device”) 345 of FIG. 3D is presented within the three-dimensional environment 355 in response to selection of the first affordance 356, 356A. As shown in FIG. 3D, in some embodiments, the augmented device 345 is optionally presented in front of the representation of first electronic device 315′. Although the representation of first electronic device 315′ is partially visible in the example of FIG. 3D, it should be understood that, in some embodiments, the augmented device 345 may be presented within the three-dimensional environment 355 to entirely occlude the display of the representation of first electronic device 315′ (e.g., such that the display of the representation of first electronic device 315′ is optionally no longer visible). In other words, in some embodiments, the position of the display of the augmented device is co-located with the display in the real-world environment. In some embodiments, augmented device 345 may not occlude the representation of first electronic device 315′. In some embodiments, the size of the augmented user interface is equivalent to the size of the display of the first electronic device 315. In some embodiments, the size of the augmented user interface is equivalent to the size of the display of the first electronic device 315 and the bezel areas around the display (e.g., expanding the size of the augmented user interface slightly beyond the dimensions of the real-world display, but constraining the size of the augmented user interface to the dimensions of the first electronic device. In some embodiments, as described herein, the size of the augmented user interface is greater than the size of the first electronic device.

As shown in FIG. 3D, in some embodiments, the second electronic device may utilize data corresponding to the user interface 314 of the first electronic device 315 to generate the augmented device 345, such that a user interface 314″ (“user interface,” “augmented user interface,” “virtual user interface”) of the augmented device 345 optionally possesses the same or a similar appearance as the user interface 314 configured to be displayed on the first electronic device 315, for example. In some embodiments, the appearances of the augmented user interface 314″ of the augmented device 345 and the user interface of the first electronic device are optionally different, as discussed in more detail with reference to FIG. 3E, for example. As shown in FIG. 3D, the user interface 314″ of the augmented device 345 is optionally a three-dimensional rendering of the real-world user interface 314 of the first electronic device 315, such that the user interface 314″ comprises some or all of the user interface elements and/or objects of the real-world user interface of the first electronic device. For example, the user interface 314″, which may include a home screen of the augmented device 345, optionally comprises augmented (e.g., virtual) representations of the application window 331″ (e.g., corresponding to the application window 331′), the one or more objects 332″ (e.g., corresponding to the one or more objects 332′), the icons 333″-339″ (e.g., corresponding to the icons 333′), and the dock 312″ (e.g., corresponding to the dock 312′). As discussed herein, in some embodiments, user interactions with one or more virtual user interface elements and/or virtual objects of the augmented device 345 optionally cause corresponding interactions to occur as interactions with one or more corresponding user interface elements and/or corresponding objects of the real-world first electronic device 315, for example.

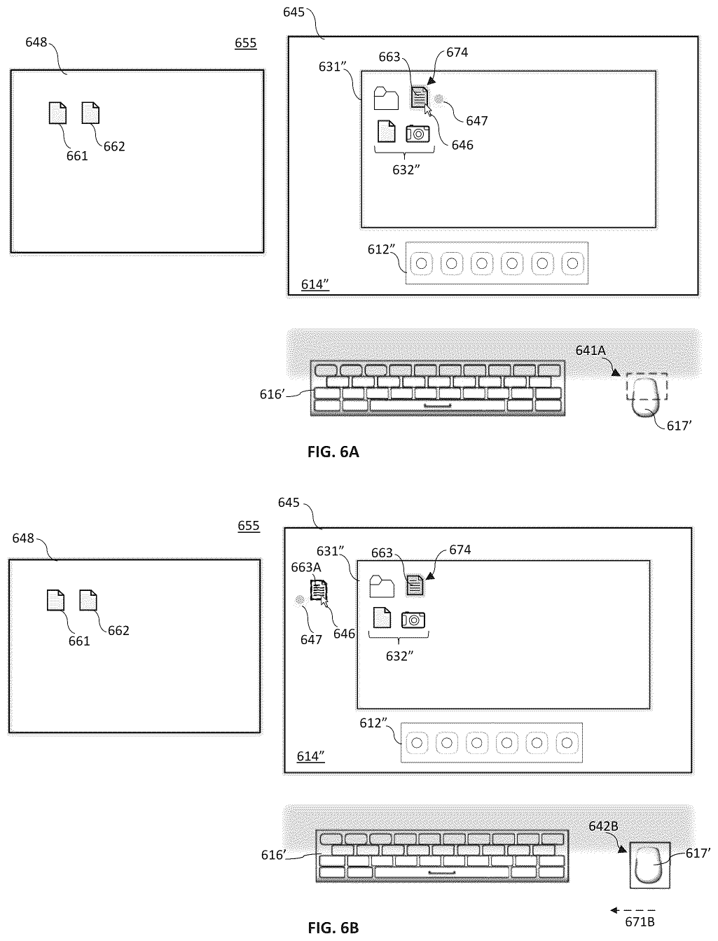

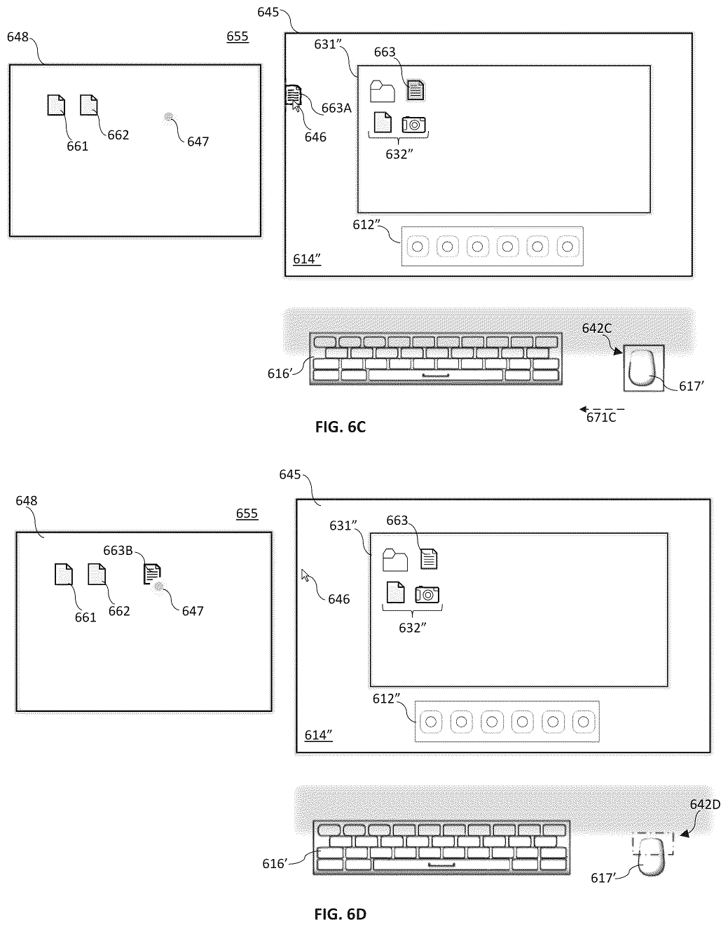

As shown in FIG. 3D, the user interface 314″ of the augmented device 345 may further comprise a (virtual) cursor 346, which optionally corresponds to real-world cursor (e.g., 325) of the first electronic device. As discussed herein, the cursor 346 is optionally controllable by the second input device 317, such that input received at the second input device (e.g., clicks/taps, movement, etc.) influences the cursor 346 displayed in the user interface of the augmented device 345. As discussed herein, the cursor 346 is optionally controllable to interact with one or more user interface elements and/or objects within the augmented user interface 314″ (e.g., controllable to move/drag one or more objects, icons and/or application windows within the user interface 314″). In some embodiments, movement of the cursor is optionally bounded by the boundaries of the user interface 314″ of the augmented device 345. For example, as the cursor 346 is moved within the user interface 314″ of the augmented device 345, if the cursor 346 is moved to a boundary of the user interface 314″, movement of the cursor beyond the boundary is optionally prevented, such that cursor 346 is displayed at the boundary as the second input device 317 controlling the cursor 346 is moved in a direction beyond the boundary, as discussed in more detail with reference to FIGS. 6A-6D.

As shown in FIG. 3D, the user interface 314″ of the augmented device 345 is optionally provided with a representation of the user's gaze 347 (e.g., the viewpoint associated with the eyes of the user of the second electronic device). In some embodiments, the gaze of the user can be represented within the three-dimensional environment 355 to assist the user with accurately and precisely focusing on one element within the augmented user interface 314″ of the augmented device 345. In some embodiments, the gaze can be represented in a similar manner as a cursor (e.g., a dot or other shape, as shown in FIG. 3D). In some embodiments, the gaze of the user may not be visually represented in three-dimensional environment 355. In some embodiments, the user's gaze may be indicated by changing the appearance of a user interface element, object or affordance within the three-dimensional environment 355 that currently has focus (e.g., brightening, highlighting, enlarging, etc. the user interface element, object or affordance that has current focus from the user's eyes), without otherwise representing gaze (e.g., there may be no indication of gaze when a user looks at window 331″ without a user focusing on specific objects 332″). As discussed herein, the cursor input received at the first electronic device 315 (e.g., via the second input device 317) may be integrated with gaze input received at the second electronic device (e.g., via eye tracking sensors 212) to improve user interactions with a real-world electronic device and to thus advantageously allow for seamless control and interaction with the augmented device 345.

In some embodiments, presenting of the augmented device 345 optionally causes the display of the first electronic device 315 to power down in the real-world environment. For example, in other words, launching of the augmented device 345 optionally causes the user interface 314 of the first electronic device 315 to cease being displayed within the real-world environment 350 and thus the three-dimensional environment 355. In some embodiments, the augmented device 345 is optionally configurable to operate in a low-power state (e.g., because the second electronic device is configurable to operate in a low-power state). In some such embodiments, for example, the display of the first electronic device 315 is powered down and/or the augmented device 345 optionally updates over fewer operating intervals to save battery power of the second electronic device.

In some embodiments, the augmented representation of the first electronic device includes a virtual user interface element (e.g., a window, pane, container, etc.) representing an extension of the display of the first electronic device. In some embodiments, the virtual user interface element is presented concurrently with the display of the first electronic device (or a representation of the display of the first electronic device). In some embodiments, a portion of the user interfaces (e.g., a first application) can be presented in a virtual user interface element (e.g., a window) of the augmented device and a portion of the user interfaces (e.g., a second application) can be presented in a representation of the display of the first electronic device. FIG. 3E illustrates an augmented device 345E including an extended display presented to the user using the second electronic device according to embodiments of the disclosure. In some embodiments, as shown in FIG. 3E, selection of the first affordance (e.g., selection of affordance 356 or 356A/356B) causes presentation of the augmented device 345E within the three-dimensional environment 355. The augmented device 345E includes an extension 348 of the display adjacent to the display of the representation of first electronic device 315′, for example. Although the representation of first electronic device 315′ appears the same in FIG. 3E as in FIG. 3B, it should be understood that, in some embodiments, the first electronic device 315′ in the augmented device 345 has an appearance like augmented device 345E in FIG. 3D. In some embodiments, the augmented representation of the first electronic device includes presenting extension 348 of the display as a virtual user interface element (e.g., a window, pane, container, etc.), and presented concurrently with the display of the first electronic device. In some embodiments, a portion of the user interface of the real-world first electronic device can be presented in the virtual user interface element of extension 348 and a portion of the user interfaces can be presented in a representation of the display of the first electronic device 315′. For example, although FIG. 3E includes window 331′ and objects 332′ in the representation of the display of the first electronic device, extension 348 can include another window 343 with additional objects/icons 330″ or representing a different application running on the first electronic device that may not have been visible on the display of the first electronic device (e.g., minimized or occluded on the display of the first electronic device). In some embodiments, dock 312″ in extension 348 includes the same user interface elements as dock 312′. In some embodiments, dock 312″ in extension 348 includes different user interface elements as dock 312′. In some embodiments, dock 312″ in extension 348 and dock 312′ share some user interface elements and have some different user interface elements.

In some embodiments, the user may select among different manifestations of an augmented device. For example, the user may select whether to launch an augmented device with one display (e.g., optionally enlarged compared with the physical display of the first electronic device in the real-world), whether to launch an augmented device with an extended display, or whether to launch a different type of augmented display. In some embodiments, upon selection of the first affordance 356, 356A, a menu comprising a plurality of configuration options may be presented to the user allowing the user to configure the augmented device. For example, the menu may provide the user with a first option for launching the augmented device 345 as a representation of the first electronic device 315′ (e.g., as shown in FIG. 3D), a second option for launching the augmented device 345E as an extended display of the first electronic device 315′ (e.g., as shown in FIG. 3E), among other possibilities. In some embodiments, additional options can be presented in the menu in which the extended display appears along a different edge of the display of the first electronic device (e.g., above, on the left side, etc.). In some embodiments, another option can be presenting the augmented device including a mirrored display (e.g., the contents of the user interface 314′ of the first electronic device 315′ are duplicated and displayed in the augmented user interface 314″ of the augmented device. The user may then select a respective option (e.g., directly or indirectly) from the menu which optionally dictates the mode of operation of the augmented device 345 presented within the three-dimensional environment 355.

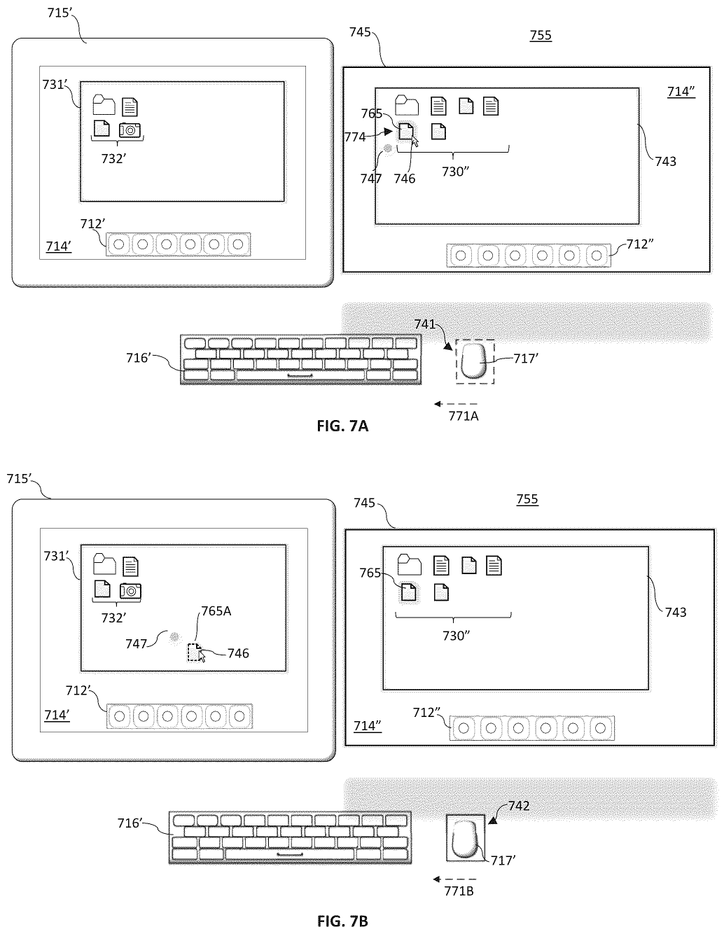

As shown in FIG. 3E, in some embodiments, while the augmented device 345E includes an extended display 348, the cursor 346, which is optionally controllable by the second input device 317, may be displayed within the user interface 314″ of the extended display 348. As discussed in more detail with reference to FIGS. 7A-7B, because the augmented device 345E in the example of FIG. 3E includes an extended display (e.g., as a second, virtual display device for the first electronic device 315′), the cursor 346 is controllable by the second input device 317 to be movable between the two user interfaces 314′ and 314″ of the augmented device 345E, for example. Additionally, in some embodiments, the cursor 346 is controllable by the second input device 317 to move one or more objects (e.g., objects 332′) and/or application windows (e.g., application window 331′ or window 343) between the user interfaces 314′ and 314″ of the augmented device 345.

As described herein, in some embodiments, a user may interact with the augmented device to modify characteristics of the virtual displays of the augmented device. FIG. 3F illustrates exemplary user interactions with the augmented device 345 within the extended reality environment 355 according to embodiments of the disclosure. In some embodiments, as shown in the example of FIG. 3F, the augmented device 345 of FIG. 3D is optionally movable within the three-dimensional environment 355. For example, in some embodiments, the augmented device 345 may be repositioned within the three-dimensional environment 355 using a direct or indirect manipulation (e.g., a gaze and pinch (e.g., using two fingers)) of a handle affordance displayed for one or more augmented device displays. For example, the user may desire to move the augmented device 345 presented in FIG. 3D to a different position in the environment (e.g., to a different position on a desk, to a different surface within the user's real-world environment, etc.). In some embodiments, the augmented device 345 may include a handle 353, optionally disposed below the augmented device 345, as shown in the example of FIG. 3F. It should be understood that the handle 353 may be alternatively disposed at or in other areas, such as, for example, above the augmented device 345, along a different edge of the augmented device 345, vertically to a side of the augmented device 345, etc. In some embodiments, an edge of the augmented device 345 can behave as a handle affordance (e.g., directly or indirectly selecting the edge rather than affordance 353).

In some embodiments, the user may provide a pinch input at or while targeting the handle 353 with gaze, as shown by pinch 342F, corresponding to a selection/gripping of the handle 353, as an example. Movement of the hand while maintaining the selection (e.g., while holding the pinch) can cause movement of the augmented device 345 in accordance with the movement of the hand. In some embodiments, the appearance of the handle 353 may change when selected. For example, in response to the input corresponding to a selection/gripping of the handle 353, the handle 353 may become highlighted, indicating to the user that the augmented device 345 may be moved. As shown in the example of FIG. 3F, while gripping/holding the handle 353, the user may reposition the augmented device 345 within the three-dimensional environment 468 (e.g., relative to the position of the augmented device in FIG. 3D, represented by 349 in FIG. 3F), as shown by dashed arrow 373 and as shown by the new position of the augmented device relative to the initial position. The user interface 314″ and its contents are moved with the augmented device 345 in accordance with the input moving the handle 353. Thus, the user may move the augmented device 345 and the various elements of the augmented user interface 314″ within the three-dimensional environment 355 by selecting and moving the handle 353. In some embodiments, releasing the pinch can cause the augmented device 345 to be released (e.g., ceases movement in accordance with movement of the hand). In some embodiments, after the user is done moving the augmented device 345 (e.g., after the pinch input 342F is released, ceasing selection of the handle 353), the handle 353 may return to its original appearance prior to selection (e.g., cease to be highlighted). In some embodiments, the handle 353 may cease to be displayed within the three-dimensional environment 355 after release of the pinch input 342F.

Although FIG. 3F illustrates movement of the augmented device of FIG. 3D, in some embodiments, the augmented device cannot be moved in a manner that causes display of the real-world first electronic device. For example, the movement of the augmented device may be limited to avoid confusion of displaying two instances of the same user interface or to avoid the user unintentionally physically contacting the first electronic device when the augmented device is not collocated with the first electronic device in the three-dimensional environment. Additionally or alternatively, although FIG. 3F illustrates movement of the augmented device of FIG. 3D, in some embodiments, similar inputs can be used to move the augmented device 345E of FIG. 3E. In some embodiments, similar inputs can be used to move the extended display of FIG. 3E relative to the display of first electronic device. For example, the input can be used to move the extended display 348 from the right side of the representation of electronic device 315′ to the left side (or top side) of the representation of electronic device 315′, without moving the representation of the first electronic device 315′).

In some embodiments, the user may change the size of the display of an augmented device 345 within the three-dimensional environment 355. Increasing the size, for example, can provide additional area to display additional or alternative features of one or more elements displayed within the augmented user interface. In some embodiments, for example, the user may change the size of the augmented device 345 to change a size of the user interface 314″ (e.g., to enlarge the user interface corresponding to the enlarged display dimensions of the augmented device). In some embodiments, the user may the user may increase or decrease the size of the augmented device 345 via eye gaze and/or using hand/finger manipulations. For example, as shown in the example of FIG. 3F, a user's gaze may target the augmented device 345 (e.g., gazing at a respective location within the augmented user interface 314″) and the user may perform a hand operation to expand or shrink the augmented device 345. The hand operation can include pinching two fingers of a first hand and pinching two fingers of a second hand and moving the two hands closer together or further apart while holding the pinching of both hands. The direction of the motion can determine whether to increase or decrease the size of the augmented device 345. In some embodiments, moving of the hands together (decreasing the distance between the pairs of pinched fingers, as indicated by arrows 371 and 372) decreases the size of the augmented device 345. For example, as shown in FIG. 3F, the augmented device 345 is shown decreased in size relative to a size of dashed rectangle 349 (e.g., relative to the size of the augmented device shown in FIG. 3D). In some embodiments, moving of the hands apart (increasing the distance between the pairs of pinched fingers) increases the size of the augmented device 345. In some embodiments, an amount of change in size of the augmented device 345 is a function (linear or non-linear) of the amount of change in distance between the two hands. In some embodiments, to expand or shrink the size of the augmented device 345, the pinching with two fingers begins at opposite sides of the device 345, as shown by pinch inputs 341A and 341B. In some embodiments, the pinching of fingers of both hands must occur within a threshold period of time. In some embodiments, direct interaction of pinching two corners can be used in a similar manner to change the size of the augmented device.

As shown in the example of FIG. 3F, in some embodiments, changing the size of the augmented device 345 changes the size of the augmented user interface 314″ including the one or more objects 332″, the application window 331″ and the dock 312″. In this way, a scaling of the augmented device 345 causes the scaling of other elements within the augmented device 345, which maintains consistency between the size of the augmented device 345 and the size of the augmented user interface 314″, which could otherwise interfere with the visibility of the elements displayed in the augmented user interface 314″ (e.g., if the application window 331″ did not shrink) and/or of the ability to interact with the elements (e.g., move one or more objects 332″, which may be difficult to do when the size and/or position of the one or more objects changes). It should be noted that, in some embodiments, increases or decreases in the size of the augmented device 345, and thus increases or decreases in the size of the elements of the augmented user interface 314″, presented at the second electronic device, is not received or construed as being an input corresponding to a request to edit or modify the actual size of the corresponding elements at the first electronic device 315′. For example, while the application window 331″ may be increased or decreased in size in accordance with an increase or decrease in size of the augmented window 335, the corresponding real-world application window (e.g., 331) displayed on the first electronic device remains unchanged (e.g., the size of the application window does not increase or decrease). In some embodiments, however, the size of the corresponding elements at the first electronic device may change in size, and optionally the amount of change in size may be scaled down (e.g., according to the ratio of size between the elements of the real-world user interface (e.g., 314) and the elements of the augmented user interface 314″ in the three-dimensional environment).

In some embodiments, as shown in the example of FIG. 3F, changes to the size of the augmented device 345, including changes to the sizes of the augmented user interface 314″ including the one or more objects 332″, the application window 331″ and the dock 312″, are optionally constrained when there is only one augmented device 345 presented using the second electronic device. For example, input directed to decreasing a size of the augmented device when there is only a single augmented device user interface 314″ (e.g., there is not extended display 348 of FIG. 3E) is optionally constrained by the physical display size (e.g., the size of the user interface 314′) of the first electronic device 315′. In other words, in some embodiments, the size of the display of the augmented device 345 optionally cannot be decreased to a size smaller than the display of the first electronic device 315′.

In some embodiments, the above principles optionally apply to changes in size of the extended display 348 of the augmented device 345E of FIG. 3E. For example, input directed to decreasing a size of the extended display 348 of the augmented device 345E is optionally constrained by the physical display size (e.g., the size of the user interface 314′) of the first electronic device 315′. In other words, in some embodiments, the size of the display of the extended display 348 optionally cannot be decreased to a size smaller than the display of the first electronic device 315′.

FIG. 3G illustrates an example user interaction with one or more user interface elements of the augmented device 345 according to embodiments of the disclosure. In some embodiments, the user may interact with one or more elements of the augmented user interface 314″ using the cursor 346, which is optionally controllable by the second input device 317. As shown in the example of FIG. 3G, in some embodiments, the user can use the cursor 346 (e.g., via click and drag input received at the second input device 317) to move one or more elements within the augmented user interface 314″. For example, the user can select the first application window 331″ using the cursor 346 and reposition the first application window 331″ within the augmented user interface 314″ of the augmented device 345 by dragging the first application window 331″, as represented by dashed arrow 371G. The user can then release selection of the first application window 331″ (e.g., release click input at the second input device 317) to drop the first application window 331″ at the new position within the augmented user interface with respect to the position indicated by 349, for example.

In some embodiments, the user can, using the cursor 346, select and move one or more of the objects 332″ within the augmented user interface 314″ (e.g., reposition one or more of the objects to a location outside of the first application window 331″). In some embodiments, movement of one or more elements of the augmented user interface 314″ optionally causes a corresponding repositioning of one or more elements of the real-world user interface of the first electronic device. For example, a repositioning of the first application window 331″ may cause a repositioning of the corresponding application window at the first electronic device in real time (e.g., within a threshold amount of time) in accordance with the repositioning at the augmented device 345. As another example, a movement of one or more objects 332″ from the first application window 331″ to another location within the augmented device 345 (e.g., to the home screen or to another application window) may cause a movement of the corresponding one or more objects to another location at the first electronic device in real time (e.g., within a threshold amount of time) in accordance with the movement at the augmented device 345.

In some embodiments, the use of the cursor 346 to target and change the size of a specific element (e.g., click and drag to expand a window size) within the augmented user interface 314″ optionally does not cause the change in size to be applied to all elements of the augmented user interface 314″. For example, a click and drag of a corner of the first application window 331″ in the augmented user interface 314″ to increase or decrease the size of the first application window 331″ does not cause the sizes of the one or more objects 332″ within the first application window 331″ to increase or decrease in size as well. In some embodiments, for example, an increase or decrease in size of one element within the augmented user interface 314″ optionally causes the change in size to be applied to the corresponding element within the real-world user interface of the first electronic device in real-time (e.g., within a threshold amount of time, such as 50 ms).

As described herein, a transfer of files between a first electronic device and a second electronic device may be provided using inputs to the first and/or second electronic devices. In some embodiments, the functionality for transferring files between the two electronic devices can be enabled during display of the augmented device as described with respect to FIGS. 3A-3G. In some embodiments, the functionality for transferring files between the two electronic devices can be enabled while presenting the representation of the first electronic device without presenting an augmented device. It may be advantageous for the user to view the exchange of files between the first electronic device (optionally via the augmented device 345) and the second electronic device within an extended reality environment. As discussed below, various methodologies are provided for interacting with and manipulating one or more elements of the user interface of the first electronic device (e.g., optionally of the augmented user interface of the augmented device), and for exchanging data between the first electronic device and the second electronic device in the three-dimensional environment.

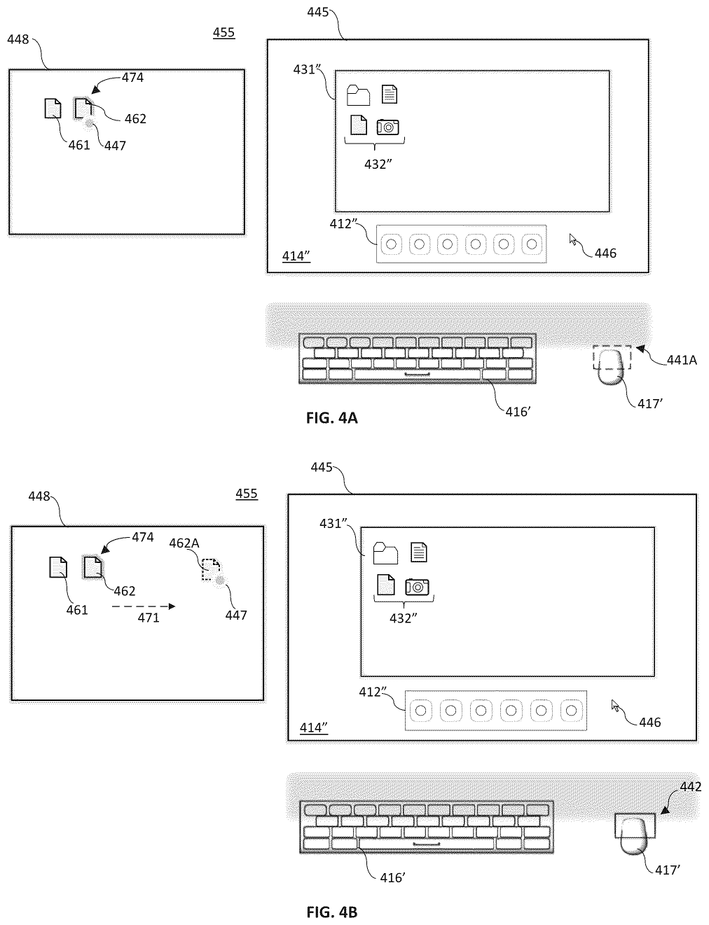

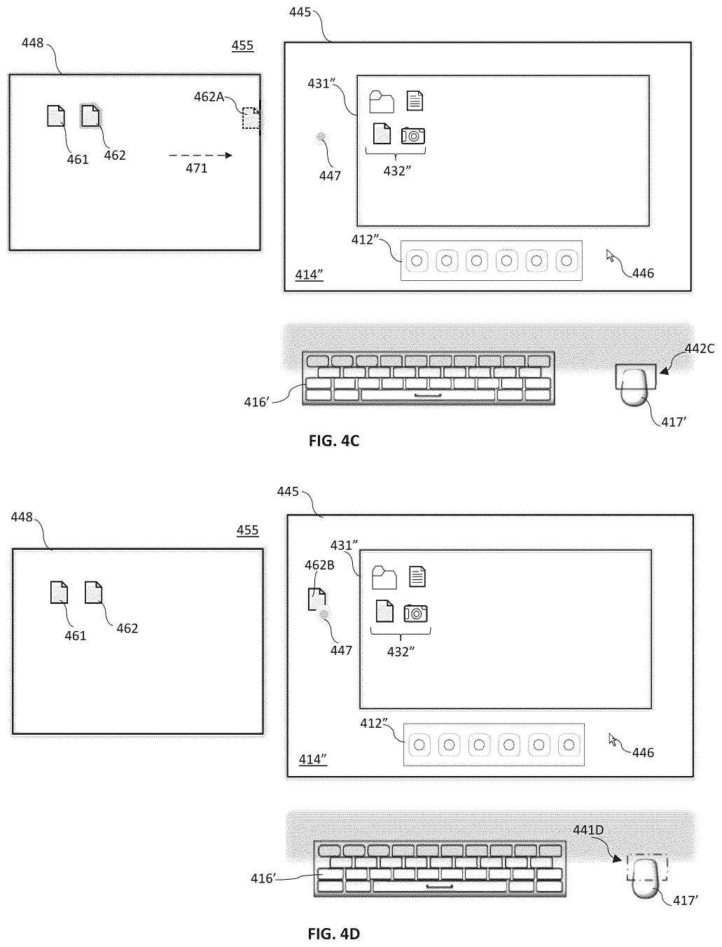

FIGS. 4A-4D illustrate example user interactions of moving an object from an application window 448 running on the second electronic device to a first device (e.g., the augmented device 445) according to embodiments of the disclosure. Although primarily described with reference to FIGS. 4A-4D as interactions with an augmented device, it is understood that the interactions can be similarly made with the representation of the first electronic device (e.g., without an augmented device) in some embodiments.

FIGS. 4A-4D illustrates a three-dimensional environment 455 presented using a second electronic device. In some embodiments, three-dimensional environment 455 includes an augmented device 445 concurrently presented with one or more additional user interfaces outside of the augmented device. Additionally or alternatively, input devices 416 and 417 (or representations thereof) may be concurrently presented in the three-dimensional environment 455 with the augmented device 445 and/or additional user interfaces outside of the augmented device. For example, the one or more user interfaces can include one or more windows, such as application window 448. The application window 448, which may optionally be a file manager application, includes a representation of a first file 461 and a representation of a second file 462. Files 461 and 462 can correspond to files stored in memory at the second electronic device (e.g., stored in memory or memories 220B). The augmented device 445 can include user interface 414″ (e.g., corresponding to user interface 314″). User interface 414″ can include a home screen application window 431″ (e.g., corresponding to the application window 331″), the one or more objects 432″ (e.g., corresponding to the one or more objects 332″), and the dock 412″ (e.g., corresponding to the dock 312″).

As discussed herein, it should be understood that, in some embodiments, objects displayed within the three-dimensional environment (e.g., representations of files, images, applications, etc.) represent real-world object data stored (e.g., in memory) on the first electronic device and/or the second electronic device. For example, objects displayed within an application window running on the second electronic device (e.g., displayed within the second application window) optionally correspond to real-world files, images, applications, etc. stored in memory on the second electronic device. As another example, objects displayed within the augmented user interface or within an application window displayed on the augmented user interface optionally correspond to real-world files, images, applications, etc. stored in memory on the first electronic device.

Attention is now directed to methodology for transferring data corresponding to the second file 462 from the second electronic device to the first electronic device via interactions directed to the augmented device 445 in the three-dimensional environment 455. As shown in the example of FIG. 4A, the user may target the second file 462 using gaze 447. In some embodiments, the gaze is optionally within a threshold distance of the second file 462 for the second file to be targeted by the second electronic device. For example, the gaze is directed toward a location within 2 cm of the planar surface of the second file 462 for the second file to be targeted by the second electronic device. In some embodiments, as shown in FIG. 4A, the gaze is optionally directed at least partially toward a portion of the second file 462 for the second file to be targeted by the second electronic device. As shown, the cursor 446, controllable by the second input device 417, is displayed within the augmented user interface 414″. As discussed above, in some embodiments, the cursor 446 is bounded by the boundaries of the user interface 414″ of the augmented device 445, such that the cursor is not controllable to navigate to the second application window 448 and move the second file 462 from the second application window 448 to the augmented user interface 414″. As discussed below, the second file 462 may be moved to the augmented user interface 414″ using a combination of gaze and selection input detected at the second input device 417.

In some embodiments, as shown in FIG. 4A, while the user targets the second file 462 using gaze, the user may provide a selection input using the second input device 417 (e.g., a click input of a mouse or trackpad), as represented by selection 441A, for example. In some embodiments, in response to receiving the click input at the second input device 417, the appearance of the second file 462 may change to indicate to the user that the second file has been selected, and the second filed can now be moved using subsequent input. For example, the second file 462 optionally becomes highlighted, as represented by highlighting 474, to indicate to the user that the second file 462 has been selected. In some embodiments, the change in appearance of the selected file can be maintained while the file remains selected (e.g., until the file is deselected).

FIG. 4B illustrates an example user interaction of moving an object from the second application window 448 toward the augmented device 445 using gaze according to embodiments of the disclosure. Continuing the example of FIG. 4A, the second file 462 may be moved from the second application window 448 to the augmented device 445 using gaze 447. In some embodiments, after selection of the second file 462, as represented by highlight 474, the user may initiate movement of the second file 462 by moving the user's gaze 447 toward the augmented device 445 (e.g., the target of the movement). As shown in the example of FIG. 4B, in some embodiments, during the movement of the second file, a shadow representation of the second file 462A may be presented within the second application window 448 within the three-dimensional environment 455 to indicate to the user that movement of the second file 462 has been initiated. In such some embodiments, the shadow representation of the second file 462A may be presented within a threshold amount of time (e.g., 50 ms) of the initiation of the movement of the gaze 447, for example, or after the gaze moves a threshold distance from the initial position of the second file upon selection.

It should be understood that, in some embodiments, a position of the shadow representation of the second file 462A may be updated incrementally and/or according to predefined time intervals (e.g., every 50 ms) relative to a current position of the user's gaze 447. For example, the gaze may change position within the three-dimensional environment 455 quickly (e.g., due to a darting of the eyes) as the second file 462 is moved from the second application window 448 to the augmented user interface 414″. Displaying the shadow representation of the second file 462A at a position within the second application window 448 that is determined relative to the current position of the gaze 447 (e.g., by applying a moving-average filter to all gaze positions captured during the predefined time interval) may prevent the shadow representation of the second file 462A from being rapidly moved within the second application window 448, which could otherwise appear disorderly and disorienting, for example.

As shown in FIG. 4B, as the user moves the gaze 447 toward the augmented device 445, as represented by dashed arrow 471, the shadow representation of the second file 462A moves in accordance with the movement of the gaze 447. It should be understood that, in some embodiments, the shadow representation of the second file 462A is displayed within a threshold distance of the actual (or approximate) location of the gaze 447. As shown in FIG. 4B, in some embodiments, while the gaze 447 moves the shadow representation of the second file 462A toward the augmented device 445, the selection input (e.g., click input) at the second input device 417 is optionally maintained, as indicated by selection 442. For example, while the user moves the gaze 447, the user continues to hold down the click input on the second input device 417. In some embodiments, the requirement for providing a constant selection input during movement of an object optionally prevents premature release/dropping of the object (and thus the object data corresponding to the representation of the object) in other areas of the three-dimensional environment 455. For example, because the gaze 447 at least partially determines a final location of the second file 462 at an end of the movement input, providing the requirement for detecting liftoff of the selection input before actually moving the second file 462 to the final location models normal computer interactions using cursors, for example. In this way, a movement of an object using gaze from an application window on the second electronic device to the user interface of the augmented device optionally only occurs if the selection input at the second input device 417 is maintained. This may prevent the object from being unintentionally moved or transferred to other application windows within the three-dimensional environment, for example, which could otherwise interfere with one or more actions associated with the other application windows (e.g., an application running in the application window), which may require corrective action be taken by the user.

FIG. 4C illustrates an example user interaction of moving an object to the augmented device 445 using gaze according to embodiments of the disclosure. Continuing the example of FIG. 4B, the second file 462 may be moved from the second application window 448 to the augmented device 445 using gaze 447. As shown in the example of FIG. 4C, the user's gaze 447 is optionally directed toward the augmented device 445 (e.g., is directed toward a respective location within augmented user interface 414″). In some embodiments, as shown in FIG. 4C, as the user's gaze 447 (and thus the shadow representation of the second file 462A) continues moving toward the augmented device 445, as shown by dashed arrow 471, when the gaze 447 crosses a boundary of the second application window 448, the shadow representation of the second file 462A is optionally prevented from crossing the boundary. For example, as shown in FIG. 4C, display of the shadow representation of the second file 462A is maintained within the second application window 448 while the gaze 447 has crossed the boundary and is directed at the augmented user interface 414″. In some embodiments, the shadow representation of the second file 462 can pass from application window 448 to the augmented device 445.

As discussed above, in some embodiments, the selection input, represented by selection 442C, is maintained at the second input device 417′ as the user moves the gaze 414″ toward the target (e.g., the respective location within the augmented user interface 414″).

FIG. 4D illustrates an example user interaction of dropping the object at a respective location within the user interface 414″ of the augmented device 445 according to embodiments of the disclosure. Continuing the example of FIG. 4C, the second file 462 may be dropped at the respective location within the user interface 414″ of the augmented device 445 in accordance with the movement described above. In some embodiments, release of the selection input provided at the second input device 417 optionally causes (a copy of) the second file 462 to be dropped at the current location of the gaze 447.

As shown in the example of FIG. 4D, in some embodiments, in response to detecting liftoff of the selection input (e.g., liftoff of the click input) provided at the second input device 417, as represented by release/liftoff 441D, a second representation of the second file 462B may be presented at the current location of the gaze 447. In some embodiments, as shown, the shadow representation of the second file (e.g., 462A) may no longer be displayed within the second application window 448 (or within the augmented device 445). In some embodiments, presenting the second representation of the second file 462B optionally corresponds to transferring of object data (e.g., file data) corresponding to the second file 462 from the second application window running on the second electronic device to the home screen (e.g., user interface 414) of the first electronic device in the real-world environment. In this way, the three-dimensional representation of the second file 462 presented in the three-dimensional environment 455 may be moved, in the manner discussed above, to the user interface 414″ of the augmented device 445 to thus transfer real-world data corresponding to the second file 462 from the second electronic device to the first electronic device (e.g., transferring the file data from the memory of the second electronic device to the memory of the first electronic device in addition to moving the graphical representation of the file from the application window 448 to the augmented display). Additionally, in some embodiments, the second file transferred in this manner is visible within the user interface of the first electronic device in the real-world (e.g., even without viewing the first electronic device using the second electronic device). In some embodiments, the object data may be deleted by the second electronic device in response to the second file 462 being moved to augmented device 445. In some embodiments, the object data transferred from the second electronic device to the first electronic device is optionally a copy of the object data, rather than a one-way transferal, such that the object data is maintained on the second electronic device (e.g., without deleting the object data from the second electronic device). For example, in response to movement of the second file 462 to the augmented user interface 414″ of the augmented device 445, the file data corresponding to the second file 462 exists on both the first electronic device (as represented by second representation 462B) and the second electronic device. Thus, one advantage of the disclosed method is that object data may be transferred between a real-world first electronic device and a real-world second electronic device by interacting with the augmented representation of the first electronic device in a three-dimensional environment. Another advantage is the seamless integration of a set of input devices of a first real-world electronic device with a set of input devices of a second real-world electronic device, which allows for input received at both sets of input devices to be directed to the same one or more objects within a three-dimensional environment.

Although, as described above, the user maintains the selection input at the second input device 417 during the movement, it is understood that in some embodiments, the selection of the second file can be completed by a first selection input and the release of the second file can be completed by a second selection input. For example, a first press and release of the mouse button or a first press and release of the trackpad, among other possible inputs, can cause selection of the second file and a subsequent press and release can cause the deselection of the second file (e.g., the placement of the second file at the new location and/or the transfer of the file data from the second electronic device to the first electronic device.

In some embodiments, the first input device 416 may also be used to provide input for moving an object from the second electronic device to the first electronic device via interaction with the augmented device 445. For example, after selection of a particular object (e.g., selection of the second file 462 using gaze 447 and click input provided at the second input device 417), the user may provide a first combination of keys on the first input device 416, which may be a keyboard, for example, corresponding to a request to duplicate the data corresponding to the particular object (e.g., make a copy of the file data corresponding to the second file 462). In some embodiments, after inputting the first combination of keys on the first input device 416, the gaze 447 may be directed toward a respective location within the augmented user interface 414″, as similarly shown in FIG. 4C, for example. In some such embodiments, the selection input (e.g., holding down of click input 442C in FIG. 4C) is optionally not required as the gaze 447 is moved from the second application window 448 toward the augmented user interface 414″. At the respective location within the augmented user interface 414″, the user may provide a second combination of keys different from the first combination of keys on the first input device 416. In response to receiving the second combination of keys, a copy of the object (e.g., the second representation of the second file 462B) may be presented at or near the current location of the gaze 447 at the respective location within the user interface 414″, as similarly shown in FIG. 4D, for example. In this way, a representation of an object in an application window at the second electronic device can seamlessly and intuitively be moved to the augmented device 445 using a combination of inputs provided at the first input device 416, the second input device 417 and the second electronic device, such that data (e.g., file data) corresponding to the object is advantageously transferred from the second electronic device to the first electronic device (e.g., 315) in the real world.

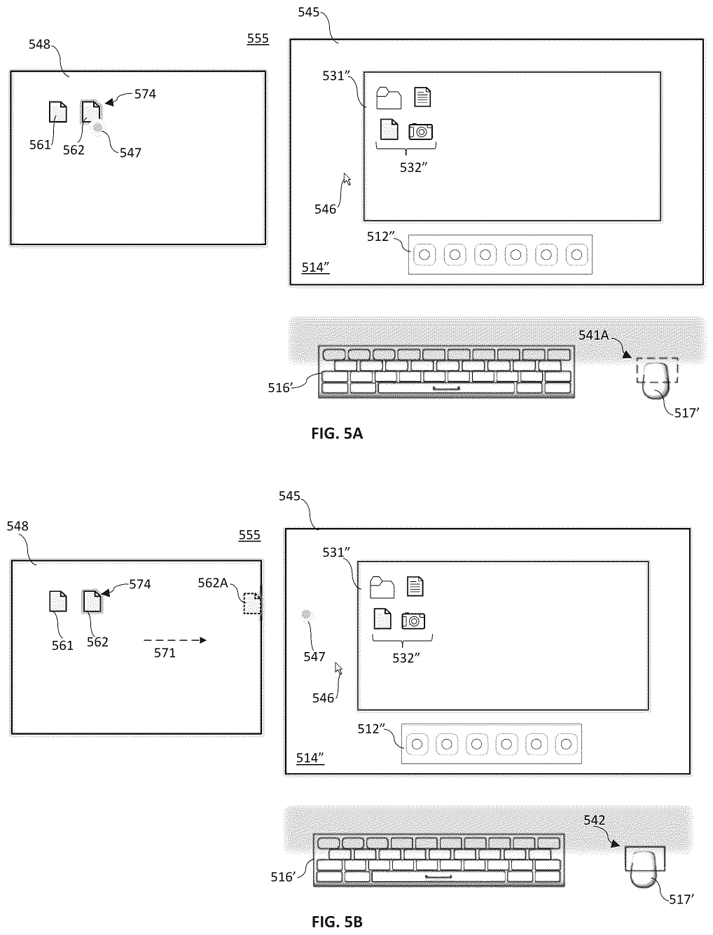

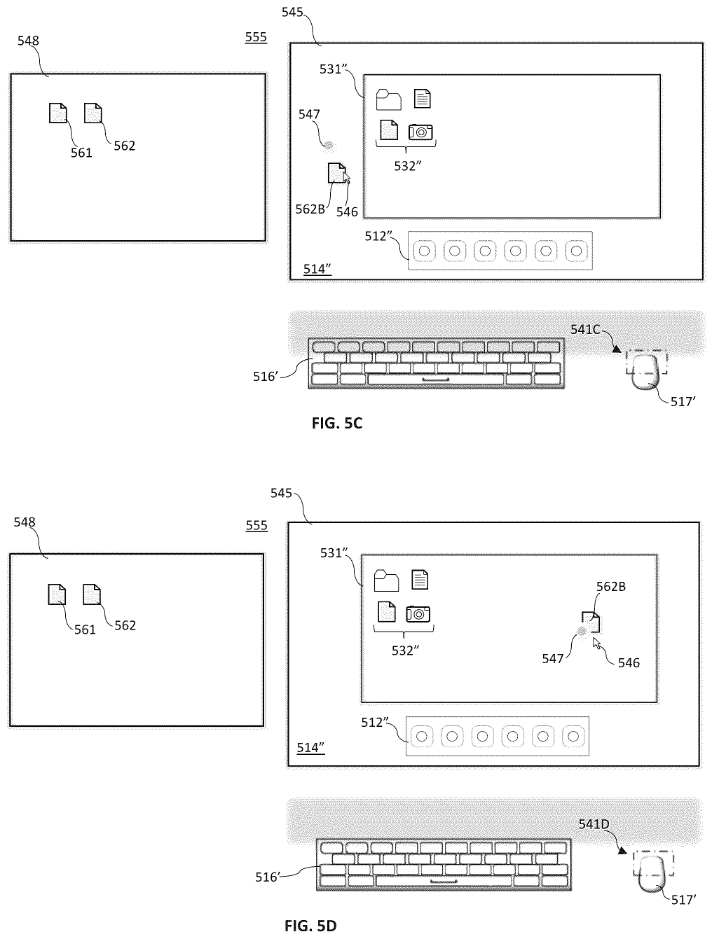

FIGS. 5A-5D illustrate exemplary user interactions of moving an object from an application window running on the second electronic device to the augmented device including a cursor according to embodiments of the disclosure. As discussed above with reference to FIGS. 4A-4D, in some embodiments, an object (e.g., a data file) can be transferred from the second electronic device to the first electronic device by interacting with the augmented device 445 in the three-dimensional environment 455. As discussed below, in some embodiments, such interactions can be impacted by a respective location of the cursor (e.g., cursor 446) within the augmented user interface of the augmented device.

FIG. 5A illustrates an example user interaction of initiating movement of an object 562 from the application window 548 to the augmented device 545 according to embodiments of the disclosure. As shown in the example of FIG. 5A, in some embodiments, a second application window 548 corresponding to a respective application running on the second electronic device is optionally presented within the three-dimensional environment 555. As discussed above, the user's gaze 547 is optionally directed toward the second object 562 to select the second object 562 for moving (e.g., transferring file data corresponding to the second object 562) from the second electronic device to the augmented user interface 414″ of the augmented device 445 (and thus from the second electronic device to the first electronic device).

As shown in the example of FIG. 5A, while the user's gaze 547 is directed toward the second file 562, a selection input (e.g., a click input) may be provided at the second input device 517 (or a representation of second input device 517′), as represented by selection 541A, to select the second file 562. In some embodiments, as discussed above, in response to receiving the selection input 541A, an appearance of the second file 562 optionally changes (e.g., becomes highlighted, as shown by highlight 574) to indicate to the user that the second file 562 is selected and can be moved from the second application window 548 to the user interface 414″ of the augmented device. As shown in FIG. 5A, the cursor 546, which is controllable by the second input device 517, is displayed within the augmented user interface 414″. As discussed below, in some embodiments, a final location of the second file 562 after movement of the second file 562 to the augmented device 545 is optionally determined based on a distance between a location of the gaze 547 and a location of the cursor 546 at the time of release.

FIG. 5B illustrates an example user interaction of moving an object from the second application window 548 toward the augmented device 545 using gaze according to embodiments of the disclosure. Continuing the example of FIG. 5A, the second file 562 may be moved from the second application window 548 to the user interface 514″ of the augmented device 545 using gaze 547. As discussed above, as the user's gaze 547 moves from the second application window 548 toward a respective location within the augmented user interface 514″ (e.g., toward the target for movement of the object data corresponding to the second file 562), a shadow representation of the second file 562A may be presented within the second application window 548. In some embodiments, the shadow representation of the second file 562A optionally moves with the gaze 547 to indicate to the user that the object data corresponding to the second file 562A is being transferred to the augmented device 545 (and thus the first electronic device). In some embodiments, the shadow representation of the second file 562A can pass from application window 548 to the augmented device 545.

As shown in the example of FIG. 5B, the user's gaze 547 is moved from the initial location of the second file 562 in the second application window 548 to a respective location within the user interface 514″ of the augmented device 545, as represented by dashed arrow 571. In some embodiments, as shown in FIG. 5B, movement of the shadow representation of the second file 562A is bounded by a boundary of the second application window 548, such that display of the shadow representation of the second file 562A is limited to the second application window 548. For example, the shadow representation of the second file 562A is displayed at the boundary of the second application window 548 while the gaze 547 has crossed the boundary and is displayed within the augmented user interface 514″. In some embodiments, confining the display of the shadow representation of the second file 562A to within the boundaries of the second application window 548 may indicate to the user that the object data corresponding to the second file 562 has not yet been transferred to the augmented device 545, and thus the first electronic device, which optionally occurs upon detecting liftoff of the selection input at the second input device 517 for example. As shown in FIG. 5B, as the user's gaze 547 is moved from the second application window 548 to the respective location within the augmented user interface 514″ in the direction of dashed arrow 571, the user may provide continuous selection input (e.g., hold down click input) at the second input device 517, as shown by selection 542, for example.

As shown in the example of FIG. 5B, the location of the gaze 547 within the augmented user interface 514″ is near a current location of the cursor 546 (e.g., within a threshold distance). For example, the cursor 546 is optionally located within the augmented user interface 514″ at a same position before the movement of the second file 562 was initiated (e.g., a same or similar position as that shown in FIG. 5A).

FIG. 5C illustrates an example user interaction of dropping the object at a respective location within the user interface 514″ of the augmented device 545 according to embodiments of the disclosure. Continuing the example of FIG. 5B, the second file 562 may be moved to the user interface 514″ of the augmented device 545 in accordance with the movement described above. In some embodiments, release of the selection input provided at the second input device 517 optionally causes the second file 562 to be dropped at the current location of the gaze at the time of release. In some embodiments, release of the selection input provided at the second input device 517 optionally causes the second file 562 to be dropped at the current location of the cursor 546. For example, the dropping the second file 562 at the current location of the cursor 546 can correspond to the cursor 546 at least partially overlapping the second file 562 or being within a threshold distance of the cursor 546 (e.g., within 5 mm).

As shown in the example of FIG. 5C, in some embodiments, the user may, while gazing at the user interface 514″ of the augmented device 545, release the selection input provided at the second input device 517 to initiate dropping of the second file 562 within the user interface 514″. For example, while the gaze is directed toward a respective location within the augmented user interface, as shown in FIG. 5C, the user may release the click input maintained at the second input device 517, as shown by release 541C, for example. In some embodiments, in response to detecting liftoff of the selection input 541C, a second representation of the second file 562B is optionally displayed within the augmented user interface 514″ and the shadow representation of the second file (e.g., 562A) is optionally no longer displayed, indicating to the user that object data corresponding to the second file 562 has been transferred from the second electronic device to the first electronic device.

As discussed above, in the example of FIG. 5C, the cursor 546 is optionally located at the same position before the movement of the second file 562 was initiated (e.g., the same or similar position as that shown in FIG. 5A). In some embodiments, a location at which the second representation of the second file 562B is displayed in the augmented user interface 514″ is the current location of the cursor 546. In some such embodiments, for example, if the gaze 547 is located within a threshold distance (e.g., less than 5 cm) of the current location of the cursor when liftoff of the selection input (e.g., release 541C) is detected at the second input device 517, the second representation of the second file 562B is optionally displayed at the current location of the cursor 546, as shown in the example of FIG. 5C. In this way, once the second representation of the second file 562B is displayed within the augmented user interface 514″ (e.g., and thus once the object data corresponding to the second file 562 is transferred from the second electronic device to the first electronic device), the user can intuitively perform additional actions on the file using the cursor 546 without requiring the user to locate and move the cursor to the current file location. For example, using the second input device 517, the user can select the second representation of the second file 562B, via a click input, for example, and drag the second representation of the second file 562B to a respective location within the first application window 531″ displayed within the augmented user interface 514″ to thus associate the object data corresponding to the second object 562 with the application corresponding to the first application window 531″. As another example, the user can select the second representation of the second file 562B, using the second input device 517, and open the object data (e.g., an image or a text document) corresponding to the second representation of the second file 562B, via a double click input, for example, and view the object data within the augmented user interface 514″.

Thus, one advantage of the disclosed method is that upon movement of an object from an application window at a second electronic device to a user interface of an augmented device corresponding to a first electronic device, the object may be displayed at a location of a cursor within the user interface for easy interaction with the object after the movement using gaze and/or the second input device 517.

FIG. 5D illustrates an alternative example user interaction of dropping the object at a respective location within the user interface 514″ of the augmented device 545 according to embodiments of the disclosure. Continuing the example of FIG. 5B, the second file 562 may be moved to the user interface 514″ of the augmented device 545 in accordance with the movement described above. In some embodiments, release of the selection input provided at the second input device 517 optionally causes the second file 562 and the cursor 546 to be dropped at the current location of the gaze 547.

As shown in the example of FIG. 5D, in some embodiments, the user may, while gazing at the user interface 514″ of the augmented device 545, release the selection input provided at the second input device 517 to initiate dropping of the second file 562 within the user interface 514″. For example, while the gaze is directed toward a respective location within the augmented user interface, as shown in FIG. 5D, the user may release the click input maintained at the second input device 517, as shown by release 541D, for example. In some embodiments, in response to detecting liftoff of the selection input 541D, a second representation of the second file 562B is optionally displayed within the augmented user interface 514″ and the shadow representation of the second file (e.g., 562A) is optionally no longer displayed, indicating to the user that object data corresponding to the second file 562 has been transferred from the second electronic device to the first electronic device.

In some embodiments, the target of the user's gaze 547 may be at a location that is far away from the current location of the cursor 546 when the second file 562 is moved from the second application window 548 to the augmented user interface 545 using the gaze 547. As shown in the example of FIG. 5D, the gaze 547 is optionally located at a different position than that shown previously in FIG. 5C (e.g., the gaze 547 is located at a respective position within the first application window 531″) within the augmented user interface 514″. In some embodiments, a location at which each of the second representation of the second file 562B and the cursor 546 is displayed in the augmented user interface 514″ is the current location of the gaze 547. In some such embodiments, for example, if the gaze 547 is not located within the threshold distance (e.g., is greater than 5 cm) of the current location of the cursor when liftoff of the selection input (e.g., release 541D) is detected at the second input device 517, the second representation of the second file 562B is optionally displayed at the current location of the gaze 547, as shown in the example of FIG. 5D. Additionally or alternatively, the cursor 546 is optionally displayed over or within a threshold distance (e.g., 5 mm) of the second file 562 at the current location of the gaze 547. Repositioning the cursor to a location at or near the second file can enable easier interaction with the file because the user does not need to locate or move the cursor for further interaction. For example, as shown in FIG. 5D, in response to detecting liftoff of the selection input 541D, the second representation of the file 562B and the cursor 546 are displayed at or near the current location of the gaze 547, which is optionally at the respective location within the first application window 531″.

As discussed above, the cursor 546, in response to detecting liftoff at the second input device 517 optionally ceases to be displayed at the position prior to detecting liftoff if the user's gaze 547 is greater than a threshold distance away from the prior position of the cursor 546. In this way, once the second representation of the second file 562B is displayed within the augmented user interface 514″ (e.g., and thus once the object data corresponding to the second file 562 is transferred from the second electronic device to the first electronic device), the user can intuitively perform additional actions using the cursor 546. For example, using the second input device 517, the user can select the second representation of the second file 562B, via a click input, for example, and drag the second representation of the second file 562B to a respective location within a third application window (not shown) displayed within the augmented user interface 514″ to thus associate the object data corresponding to the second object 562 with the application corresponding to the third application window. As another example, the user can select the second representation of the second file 562B, using the second input device 517, and open the object data (e.g., an image or a text document) corresponding to the second representation of the second file 562B, via a double click input, for example, and view the object data within the augmented user interface 514″.

Thus, one advantage of the disclosed method is that upon movement of an object from an application window at a second electronic device to a user interface of an augmented device corresponding to a first electronic device, the object and the cursor may be displayed at a location of the user's gaze within the user interface for easy interaction with the object after the movement.

Although, as described above, the user maintains the selection input at the second input device 517 during the movement, it is understood that in some embodiments, the selection of the second file can be completed by a first selection input and the release of the second file can be completed by a second selection input. For example, a first press and release of the mouse button or a first press and release of the trackpad, among other possible inputs, can cause selection of the second file and a subsequent press and release can cause the deselection of the second file (e.g., the placement of the second file at the new location and/or the transfer of the file data from the second electronic device to the first electronic device.

FIGS. 6A-6D illustrate example user interactions of moving an object from the augmented device to an application window running on the second electronic device using the cursor according to embodiments of the disclosure. As discussed above with reference to FIGS. 4A-5D, in some embodiments, data corresponding to an object can be transferred from the second electronic device to the first electronic device in the real-world environment by interacting with the augmented device in the three-dimensional environment. As discussed below, in some embodiments, data corresponding to an object can be transferred from the first electronic device to the second electronic device by interacting with the augmented device 645.

FIG. 6A illustrates an example user interaction of initiating movement of an object 663 from the application window 631″ of the augmented device 645 to a second application window 648 at the second electronic device according to embodiments of the disclosure. In some embodiments, the first electronic device may comprise data corresponding to one or more applications, files, user interface elements, etc. stored in memory at the first electronic device (e.g., stored in memory or memories 220A). In some embodiments, the user may launch a respective application at the augmented device 645, where an application window 631″ corresponding to the respective application is presented within the augmented user interface 614″. As shown in the example of FIG. 6A, in some embodiments, the user can open the second application window 648, different than the first application window 631″ displayed on the augmented device 645, for example, presented within the three-dimensional environment 655.

As shown in FIG. 6A, the second application window 648, which may be a file manager application, for example, optionally includes a (representation of a) first file 661 and a (representation of a) second file 662. The first application window 631″ optionally includes one or more objects 632″, including a (representation of a) third file 663. Attention is now directed to methodology for transferring data corresponding to the third file 663 from the first electronic device to the second electronic device via interactions directed to the augmented device 645 in the three-dimensional environment 655. As shown in the example of FIG. 6A, the user may target the third file 663 using gaze 647. In some embodiments, the gaze is optionally within a threshold distance of the third file 663 for the third file to be targeted by the second electronic device. For example, the gaze is directed toward a location within 2 cm of the planar surface of the third file 663 for the third file to be targeted by the second electronic device. In some embodiments, the gaze is optionally directed at least partially toward a portion of the third file 663 for the third file to be targeted by the second electronic device. As shown, the cursor 646, controllable by the second input device 617 (or a representation of second input device 617′), is displayed within the augmented user interface 614″. As discussed above, the cursor 646 is bounded by the boundaries of the user interface 614″ of the augmented device 645, such that the cursor is not controllable to navigate to the second application window 648 and move the third file 662 from the first application window 631″ directly to the second application window 648. As discussed below, the third file 663 may be moved to the second application window 648 using a combination of gaze and/or cursor movement detected using the second input device 617.

In some embodiments, as shown in FIG. 6A, while the user targets the third file 663 using gaze 647 or using cursor 646, the user may select the third file 663 via a selection input (e.g., a click input) detected at the second input device 617, as represented by selection 641A, for example. In some embodiments, in response to detecting the click input at the second input device 617, the appearance of the third file 663 may change (e.g., become highlighted, as represented by highlight 674) to indicate to the user that the second file has been selected and can now be moved.

FIG. 6B illustrates an example user interaction of moving an object from the first application window 631″ of the augmented device 645 toward a second application window 648 using gaze 647 or using the cursor 646 according to embodiments of the disclosure. Continuing the example of FIG. 6A, the third file 663 may be moved from the first application window 631″ to the second application window 648 using gaze 647 or the cursor 646 in accordance with a first portion of the input. In some embodiments, after selection of the third file 663, as represented by highlight 674, the user may initiate movement of the third file 663 by moving gaze 647 or the cursor 646 toward the second application window 648 (e.g., the target of the movement). As shown in the example of FIG. 6B, in some embodiments, a shadow representation of the third file 663A may be presented within augmented user interface 614″ of the augmented device 645 to indicate to the user that movement of the third file 663 has been initiated. In some such embodiments, the shadow representation of the third file 663A may be presented within a threshold amount of time (e.g., 50 ms) of the initiation of the movement of the cursor 646, for example. It should be understood that, in some embodiments, a position of the shadow representation of the third file 663A may be updated incrementally or in predefined time intervals (e.g., every 50 ms) in accordance with changes in movement detected at the second input device 617.

As shown in FIG. 6B, as the user moves gaze 647 or the cursor 646 toward the second application window 648 using the second input device 617, as represented by dashed arrow 671B, the shadow representation of the third file 663A moves in accordance with the movement of the cursor 646. It should be understood that, in some embodiments, the shadow representation of the third file 663A is displayed within a threshold distance of the actual (or approximate) location of gaze 647 or the cursor 646. As shown in FIG. 6B, in some embodiments, while gaze 647 or the cursor 646 moves the shadow representation of the third file 663A toward the second application window 648, the selection input (e.g., click input) at the second input device 617 is optionally maintained, as indicated by selection 642B. For example, while the user moves gaze 647 or the cursor 646, the user continues to hold down the click input on the second input device 617′.

FIG. 6C illustrates an example user interaction of moving an object to the second application window 648 using gaze 647 according to embodiments of the disclosure. Continuing the example of FIG. 6B, the third file 663 may be moved from the first application window 631″ to the second application window 648 using gaze 647. As shown in the example of FIG. 6C, the user's gaze 647 is optionally directed toward the second application window 648 (e.g., is directed toward a respective location within the second application window 648.) In some embodiments, as shown in FIG. 6C, as the cursor 646 (and thus the shadow representation of the third file 663A) continues moving toward the second application window 648, as shown by dashed arrow 671C, when the cursor 646 reaches a boundary of the augmented user interface 614″, the cursor 646 and the shadow representation of the third file 663A are optionally prevented from crossing the boundary. For example, as shown in FIG. 6C, display of the shadow representation of the third file 663 and the cursor 646 are maintained within the user interface 614″ of the augmented device 645 as the gaze 647 crosses the boundary of the user interface 614″ and moves to a respective location within the second application window 648.

As discussed above, in some embodiments, the display of the cursor 646 is bounded by the boundaries of the user interface 614″ of the augmented device 645. Additionally or alternatively, in some embodiments, the display of the shadow representation of the third file 663A is bounded by the boundaries of the user interface 614″ of the augmented device 645. Because the representation of the third file 663 at the augmented device 645 corresponds to object data (e.g., file data) stored on the first electronic device, the shadow representation of the third file 663 is optionally confined to the display of the augmented device 645 to indicate to the user that the object data corresponding to the third file 663 has not yet been transferred to the second electronic device. In some embodiments, the shadow representation of the second file 663A and/or the cursor 646 can pass from application window 548 to the augmented device 545 in accordance with the movement of the third file 663. As discussed below, because movement and display of the cursor 646 is bounded by the boundaries of the augmented user interface 614″, a second portion of the movement of the third file 663 to the second application window 648 is optionally performed using gaze 647.

FIG. 6D illustrates an example user interaction of dropping the object at a respective location within the second application window 648 within the three-dimensional environment 655 according to embodiments of the disclosure. Continuing the example of FIG. 6C, the third file 663 may be dropped at the respective location within the second application window 648 of the second electronic device in accordance with a second portion the movement input. In some embodiments, release of the selection input provided at the second input device 617 optionally causes the third file 663 to be dropped at the current location (or within a threshold distance) of the gaze 647.

As shown in the example of FIG. 6D, in some embodiments, in response to detecting liftoff of the selection input (e.g., liftoff of the click input) provided at the second input device 617, as represented by release/liftoff 642D, a second representation of the third file 663B may be presented at the current location of the gaze 647. In some embodiments, as shown, the shadow representation of the third file (e.g., 663A) may no longer be displayed within the user interface 614″ of the augmented device 645. In some embodiments, presenting the second representation of the third file 663B optionally corresponds to transferring of object data (e.g., file data) corresponding to the third file 663 from the first application window 631″ running on the augmented device 645 to the second application window 648 running on the second electronic device in the real-world environment. In this way, the three-dimensional representation of the third file 663 presented in the three-dimensional environment 455 may be moved, in the manner discussed above, to the user interface 414″ of the augmented device 445 to thus transfer real-world data corresponding to the second file 462 from the second electronic device to the first electronic device. In some embodiments, the object data transferred from the second electronic device to the first electronic device is optionally a copy of the object data, rather than a one-way transferal, such that the object data is maintained on the first electronic device. For example, in response to movement of the third file 663 to the second application window 648 in the three-dimensional environment 655, the file data corresponding to the third file 663 exists on both the first electronic device and the second electronic device (as represented by second representation 663B). Thus, one advantage of the disclosed method is that object data may be transferred between a real-world first electronic device and a real-world second electronic device by interacting with the augmented representation of the first electronic device in a three-dimensional environment. Another advantage is the seamless integration of a set of input devices of a first real-world electronic device with a set of input devices of a second real-world electronic device, which allows for input received at both sets of input devices to be directed to the same one or more objects within a three-dimensional environment.

In some embodiments, the first input device 616 may also be used to provide input for moving an object from the first electronic device to the second electronic device via interaction with the augmented device 645. For example, after selection of a particular object (e.g., selection of the third file 663 using the cursor 646 controlled by the second input device 617), the user may provide a first combination of keys on the first input device 616, which may be a keyboard, for example, corresponding to a request to duplicate the data corresponding to the particular object (e.g., make a copy of the file data corresponding to the third file 663). In some embodiments, after inputting the first combination of keys on the first input device 616, the gaze 647 may be directed toward a respective location within the second application window 648, as similarly shown in FIG. 6C, for example. In some such embodiments, the selection input (e.g., holding down of click input 642C in FIG. 6C) is optionally not required as the gaze 647 is moved from the first application window 631″ toward the second application window 648. At the respective location within the second application window 648, the user may provide a second combination of keys different from the first combination of keys on the first input device 616. In response to receiving the second combination of keys, a copy of the object (e.g., the second representation of the third file 663B) may be presented at or near the current location of the gaze 647 at the respective location within the second application window 648, as similarly shown in FIG. 6D, for example. In this way, a representation of an object in an application window at the first electronic device can seamlessly and intuitively be moved to the a second application window running on the second electronic device using a combination of inputs provided at the first input device 616, the second input device 617 and the second electronic device, such that data (e.g., file data) corresponding to the object is advantageously transferred from the first electronic device (e.g., 315) to the second electronic device in the real world.

FIGS. 7A-7B illustrate exemplary user interactions of moving an object between the augmented device 745 and a user interface of the first electronic device while the augmented device functions as an extended display according to embodiments of the disclosure. FIG. 7A illustrates an exemplary user interaction of selecting an object displayed within the augmented user interface 714″ using the cursor 746 while the augmented user interface functions as an extended display for the first electronic device (representation of first electronic device 715′) according to embodiments of the disclosure. As discussed previously with reference to FIG. 3E, in some embodiments, the augmented device 735 is optionally configurable to operate as an extended display for the representation of first electronic device 715′. For example, the user may launch the augmented device 745 as an extended display of the user interface 714′ (e.g., the home screen) of the representation of first electronic device 715′ after selection of the first affordance (e.g., first affordance 356). As shown in the example of FIG. 7A, in some embodiments, a second plurality of objects (e.g., representations of files, folders, images, etc.) 730″ is optionally displayed within a third application window 743 of the user interface 714″ of the augmented device 745. As discussed below, in some embodiments, one or more objects of the second plurality of objects 730″ can be selected and moved between the user interface 714′ of the representation of first electronic device 715′ and the augmented user interface 714″ of the augmented device 745 using the cursor 746.

As shown in the example of FIG. 7A, in some embodiments, a fourth file 765 (e.g., a fourth object) of the second plurality of objects 730″ may be selected using the cursor 746. For example, selection input provided at the second input device (representation of second input device 717′), as represented by selection 741, optionally causes the cursor 746 to select the fourth file 765. In response to detecting the selection, an appearance of the fourth file 765 may change (e.g., the fourth file 765 optionally becomes highlighted, as represented by highlight 774) to indicate to the user that the fourth file 765 has been selected by the cursor 746, for example. The user may then initiate movement of the fourth file 765 from the third application window 743 of the augmented user interface 714″ (e.g., the extended display) to the user interface 714′ of the representation of first electronic device, as indicated by dashed arrow 771A, for example.

It should be understood that, in some embodiments, the fourth file 765 optionally represents object data stored on the first electronic device. Moreover, the second plurality of objects 730″ optionally represent object data corresponding to files, folders, images, etc. stored on the first electronic device and/or associated with an application corresponding to the third application window 743, for example.

FIG. 7B illustrates an exemplary user interaction of moving an object from the augmented user interface 745 to the user interface of the first electronic device using the cursor 746 while the augmented user interface 745 functions as an extended display according to embodiments of the disclosure. As shown in the example of FIG. 7B, using the cursor 746 (e.g., controllable by the second input device 717, as indicated by arrow 742), the fourth file 765 can be moved from the augmented user interface 714″ of the augmented device 745 to the user interface 714′ of the representation of first electronic device 715′, as represented by dashed arrow 771B. For example, the second plurality of objects 730″, and thus the fourth file 765, may be contained within the third application window 743 or a second home screen of the first electronic device (e.g., in the real-world environment). As shown in FIG. 7B, the fourth file 765 may be moved to the first application window 731′ of the user interface 714′ to associate the object data corresponding to the fourth file 765 with the application corresponding to the first application window 731′, for example.

As shown in the example of FIG. 7B, in response to initiation of movement of the fourth file 765 toward the first application window 731′, a shadow representation of the fourth file 765A is optionally displayed at a position of the cursor 746 to indicate to the user that movement of the fourth file 765 has begun. As shown, the shadow representation of the fourth file 765A and the cursor 746 have been moved from the third application window 743 of the augmented user interface 714″ to the first application window 731′ at the representation of first electronic device 715′. As shown in FIG. 7B, in some embodiments, while the augmented device functions as an extended display for the representation of first electronic device 715′, the cursor 746 (and thus the shadow representation 765A) can be seamlessly moved from the augmented user interface 745 to a respective location within the user interface 714′ of the representation of first electronic device 715′. In some such embodiments, the cursor 746 (and thus the shadow representation 765A) is optionally no longer bounded by the boundaries of the augmented user interface 714″ of the augmented device 745. In this way, while the augmented device 745 operates as an extend display of the representation of first electronic device 715′, the user can intuitively use the cursor 746 to move objects (e.g., file data) between application windows displayed on the representation of first electronic device 715′ and the augmented device 745.

Additionally or alternatively, in some embodiments, the user interactions directed toward the augmented device and one or more application windows and objects of the augmented device, and one or more application windows running on the second electronic device, different than those displayed on the augmented device, can be provided using hand input detected by the hand tracking sensor(s) (e.g., hand tracking sensor(s) 202) of the second electronic device. For example, the cursor presented within the augmented user interface of the augmented device may be configured to be controllable via hand and/or finger input detected at the second electronic device. In some such embodiments, the user can move the cursor by moving a position of the hand, and select and drag an object (e.g., a file) by targeting the object using gaze and pinching the object with two fingers, for example. The gaze may be directed toward a drop target (e.g., an application window running on the second electronic device (e.g., second application window 648)) and the pinch input may be released, which optionally causes a second representation of the object to be dropped at the drop target, and thus optionally causes object data corresponding to the object to be transferred to the target device (e.g., the second electronic device).

It is understood that the embodiments shown and described herein are merely exemplary and that additional and/or alternative elements may be provided within the three-dimensional environment and/or within the augmented device. It should be understood that the appearance, shape, form and size of each of the various user interface elements and objects shown and described herein are exemplary and that alternative appearances, shapes, forms and/or sizes may be provided. For example, the augmented device may be provided in an alternative shape than a rectangular shape, such as a circular shape, oval shape, etc. In some embodiments, for example, the first affordance (e.g., first affordance 356) may be selected vocally via user vocal commands (e.g., “select affordance” vocal command) and/or the augmented device may be launched vocal via user vocal commands (e.g., “launch augmented device” vocal command). Additionally or alternatively, in some embodiments, the augmented device and an application window running on the second electronic device may be configurable to operate in a workspace mode. An anchor point (not shown) is optionally provided between the augmented device and the application window in the three-dimensional environment. In some such embodiments, the augmented device and the application window may be concurrently moved (e.g., repositioned), resized, etc. within the three-dimensional environment (e.g., similar in manner to the interactions shown in FIG. 3F) at the same relative amount, magnitude, etc., in accordance with such manipulations, for example.

Additionally or alternatively, multiple augmented devices may be launched concurrently and/or files may be transferred between multiple electronic devices. As discussed previously with reference to FIG. 3C, the second electronic device (e.g., the head-mounted display) may be configured to detect multiple electronic devices, such as the first electronic device 315, which may be a desktop computer, for example, and the third electronic device 318, which may be a tablet computer, for example. Augmented devices can be launched for both the first electronic device 315 and the third electronic device 318 (e.g., by selecting both affordances 356A and 356B). In some embodiments, launching of augmented devices for both the first electronic device 315 and the third electronic device 318 may allow a user to exchange and/or transfer object data (e.g., file data, image data, application data, etc.) between the first electronic device and the second electronic device, between the second electronic device and the third electronic device, and/or between the first electronic device and the third electronic device in a similar manner as described herein with respect to FIGS. 4A-4C, 5A-5C, and 6A-6C.

Additionally or alternatively, in some embodiments, multiple head-mounted displays (e.g., each corresponding to device 240 in FIG. 2) can be used. In some such embodiments, a first electronic device (e.g., a desktop computer, laptop computer, etc.) can be presented to a first user of a second electronic device (e.g., a first head-mounted display) and can be presented to a second user of a third electronic device (e.g., a second head-mounted display). In some embodiments, either of the second and third electronic devices may be used to launch an augmented device corresponding to the first electronic device in a three-dimensional environment. In some embodiments, only one of the head-mounted devices can launch the augmented device, but the augmented device can be presented using the second and the third electronic devices. For example, the objects, application windows, user interface elements, etc. displayed on each augmented device corresponding to the first electronic device is optionally shared between the second electronic device and the third electronic device. As such, manipulations performed by one user on the second electronic device (e.g., movement of an object) is viewable by the other user on the third electronic device (e.g., the same movement of the object). It should be understood that, in some such embodiments, a criterion for detecting the first electronic device by the second electronic device and the third electronic device is optionally that each of the second electronic device and the third electronic device has received authorization to share the same data with the first electronic device, for example. The second electronic device and the third electronic device are thus optionally engaged in a shared viewing experience utilizing the same three-dimensional environment and the same data of the first electronic device (e.g., rather than duplicates of the data, which could otherwise result in contradicting transfer and/or exchange of the data).

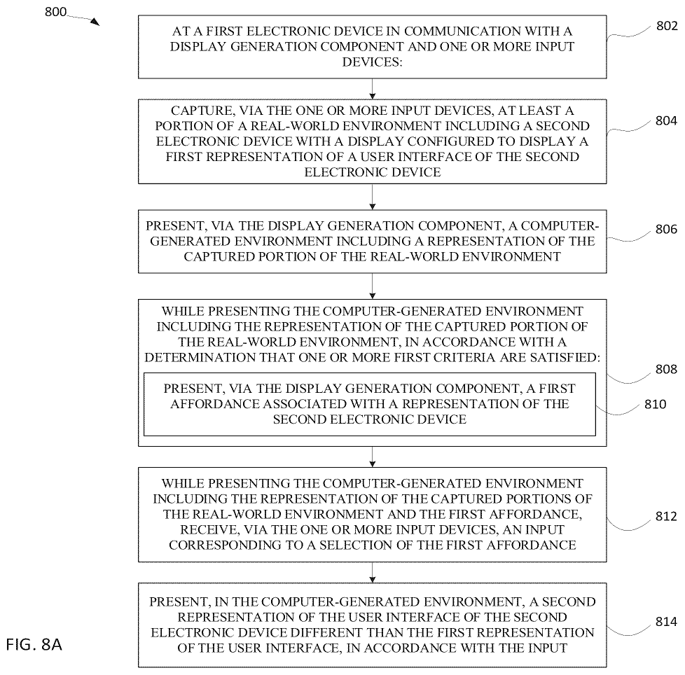

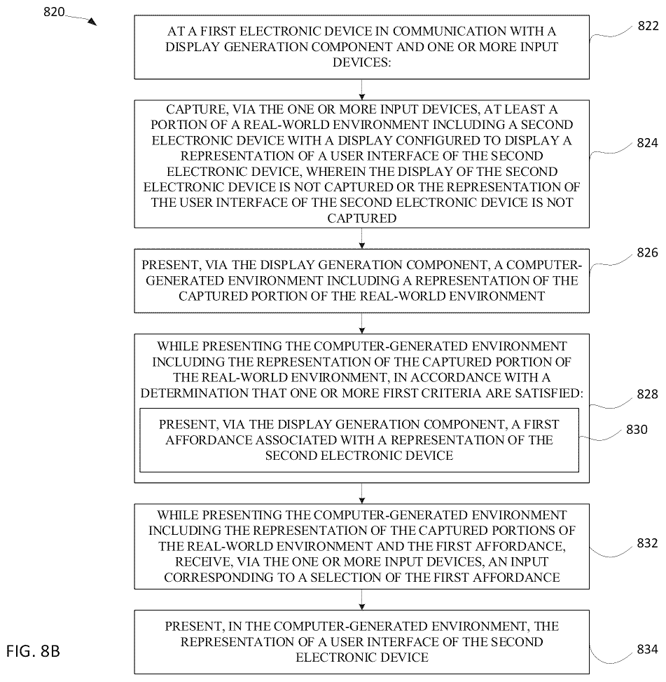

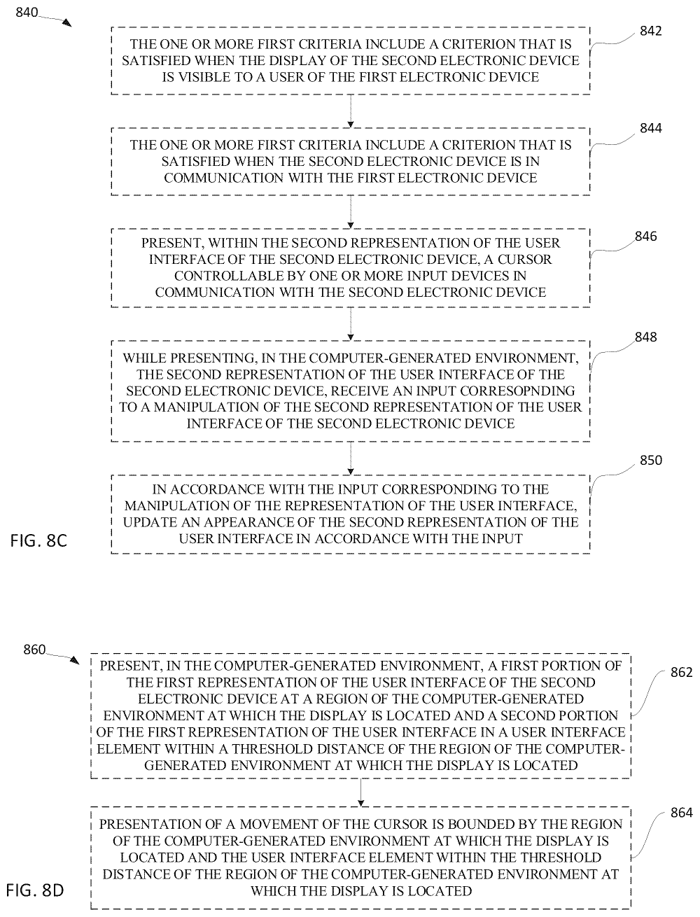

FIGS. 8A-8D illustrate flow diagrams illustrating example processes for presenting an augmented device corresponding to an electronic device according to embodiments of the disclosure. As shown in FIG. 8A, process 800 begins at a first electronic device in communication with a display generation component (e.g., a display) and one or more input devices, at 802. In some embodiments, the first electronic device is optionally a head-mounted display similar or corresponding to device 240 of FIG. 2. As shown at 804, the first electronic device may capture, via the one or more input devices, at least a portion of a real-world environment including a second electronic device with a display configured to display a first representation of a user interface of the second electronic device. In some embodiments, the second electronic device may be a laptop computer, a desktop computer, or a tablet computer, among other possibilities, similar or corresponding to device 230 of FIG. 2. Additionally, in some embodiments, the display of the second electronic device is optionally configured to display a user interface comprising one or more user interface elements and/or one or more objects, such as user interface 315/315′ of FIGS. 3A-3G, for example.

At 806, the first electronic device may present, via the display generation component, a computer-generated environment including a representation of the captured portion of the real-world environment. In some embodiments, the first electronic device may present a three-dimensional environment, such as three-dimensional environment 355 of FIGS. 3B-3G, including three-dimensional representations of one or more real-world objects, such as the second electronic device and the first representation of the user interface of the second electronic device. As shown in FIG. 8A, while presenting the computer-generated environment including the representation of the captured portion of the real-world environment, in accordance with a determination that one or more criteria are satisfied, at 808, the first electronic device may present, via the display generation component, a first affordance associated with a representation of the second electronic device, at 810. For example, in some embodiments, the first electronic device may present a first affordance, such as first affordance 356 in FIG. 3B, within the three-dimensional environment and optionally at, above, and/or near the representation of the second electronic device, where the first affordance is selectable to launch an augmented device corresponding to the second electronic device.

At 812, while presenting the computer-generated environment including the representation of the captured portions of the real-world environment and the first affordance, the first electronic device may receive, via the one or more input devices, an input corresponding to a selection of the first affordance. For example, in some embodiments, the user may select the first affordance by directly or indirectly tapping, pinching, or otherwise touching the first affordance within the three-dimensional environment, which is optionally received by hand-tracking sensors in communication with the first electronic device. As shown in FIG. 8A, the first electronic device may present, in the computer-generated environment, a second representation of the user interface of the second electronic device different than the first representation of the user interface, in accordance with the input, at 814. In some embodiments, the first electronic device may launch an augmented device, such as augmented device 345 of FIG. 3D, displaying a second representation of the user interface of the second electronic device (e.g., augmented user interface 314″), where the second representation of the user interface optionally includes one or more user interface elements (e.g., application window 331″) and/or one or more objects (e.g., objects 332″) of the first representation of the user interface.

In some embodiments, the second electronic device may be in a respective state in which the display and/or the representation of the user interface of the second electronic device are not visible and/or capturable by the first electronic device. In some such embodiments, the first electronic device is configurable to launch an augmented device corresponding to the second electronic device despite the display and/or the representation of the user interface not being visible and/or capturable. As shown in FIG. 8B, process 820 begins at a first electronic device in communication with a display generation component and one or more input devices, at 822. In some embodiments, the first electronic device is optionally a head-mounted display similar or corresponding to device 240 of FIG. 2. As shown at 824, the first electronic device may capture, via the one or more input devices, at least a portion of a real-world environment including a second electronic device with a display configured to display a first representation of a user interface of the second electronic device. In some embodiments, the display of the second electronic device is not captured or the representation of the user interface of the second electronic device is not captured. In some embodiments, the second electronic device may be a laptop computer, a desktop computer, or a tablet computer, among other possibilities, that is in a respective state in which the display or the user interface of the device is not captured (e.g., the device is in a low-power state, in a shut-off state, in a sleep state, etc.). Additionally, in some embodiments, the display of the second electronic device is optionally configured to display a user interface comprising one or more user interface elements and/or one or more objects, such as user interface 315/315′ of FIGS. 3A-3G, for example.

At 826, the first electronic device may present, via the display generation component, a computer-generated environment including a representation of the captured portion of the real-world environment. In some embodiments, the first electronic device may present a three-dimensional environment, such as three-dimensional environment 355 of FIGS. 3B-3G, including three-dimensional representations of one or more real-world objects, such as the second electronic device and the first representation of the user interface of the second electronic device. As shown in FIG. 8B, while presenting the computer-generated environment including the representation of the captured portion of the real-world environment, in accordance with a determination that one or more criteria are satisfied, at 828, the first electronic device may present, via the display generation component, a first affordance associated with a representation of the second electronic device, at 830. For example, in some embodiments, the first electronic device may present a first affordance, such as first affordance 356 in FIG. 3B, within the three-dimensional environment and optionally at, above, and/or near the representation of the second electronic device, where the first affordance is selectable to launch an augmented device corresponding to the second electronic device.

At 832, while presenting the computer-generated environment including the representation of the captured portions of the real-world environment and the first affordance, the first electronic device may receive, via the one or more input devices, an input corresponding to a selection of the first affordance. For example, in some embodiments, the user may select the first affordance by directly or indirectly tapping, pinching, or otherwise touching the first affordance within the three-dimensional environment, which is optionally received by hand-tracking sensors in communication with the first electronic device. As shown in FIG. 8B, the first electronic device may present, in the computer-generated environment, a second representation of the user interface of the second electronic device different than the first representation of the user interface, in accordance with the input, at 834. In some embodiments, the first electronic device may launch an augmented device, such as augmented device 345 of FIG. 3D, displaying a second representation of the user interface of the second electronic device (e.g., augmented user interface 314″), where the second representation of the user interface optionally includes one or more user interface elements (e.g., application window 331″) and/or one or more objects (e.g., objects 332″) of the first representation of the user interface.

Additionally or alternatively, as shown in process 840 of FIG. 8C, the one or more first criteria include a criterion that is satisfied when the display of the second electronic device is visible to a user of the first electronic device, at 842. For example, in some embodiments, the display of the second electronic device is within a field of view of the user of the first electronic device (e.g., of the head-mounted display), as shown in FIG. 3A, for example. In some embodiments, at 844, the one or more first criteria include a criterion that is satisfied when the second electronic device is in communication with the first electronic device. For example, in some such embodiments, the first electronic device and the second electronic device communicate via a wired or wireless communication channel. Additionally or alternatively, at 846, the first electronic device may present, within the second representation of the user interface of the second electronic device, a cursor controllable by one or more input devices in communication with the second electronic device. At 848, while presenting, in the computer-generated environment, the second representation of the user interface of the second electronic device, the first electronic device may receive an input corresponding to a manipulation of the second representation of the user interface of the second electronic device. For example, the first electronic device may receive an input, via the cursor controllable by the one or more input devices in communication with the second electronic device, corresponding to movement of an application window (e.g., application window 331″) within the augmented user interface (e.g., augmented user interface 314″). In accordance with the input corresponding to the manipulation of the representation of the user interface, at 850, the first electronic device may update an appearance of the second representation of the user interface in accordance with the input (e.g., move the application window in accordance with the cursor movement).

In some embodiments, as described with reference to FIGS. 7A-7B, the augmented device may include an extended display window (e.g., extended display 745). As shown in process 860 of FIG. 8D, the first electronic device may present, in the computer-generated environment, a first portion (e.g., user interface 714′ of the first electronic device of FIG. 7A) of the first representation of the user interface of the second electronic device at a region of the computer-generated environment at which the display is located and a second portion (e.g., augmented user interface 714″ of extended display window 745) of the first representation of the user interface in a user interface element within a threshold distance of the region of the computer-generated environment at which the display is located. At 864, presentation of a movement of the cursor is bounded by the region of the computer-generated environment at which the display is located and the user interface element within the threshold distance of the region of the computer-generated environment at which the display is located. For example, the cursor displayed within the augmented device, as shown in FIG. 7B, is controllable by the one or more input devices in communication with the second electronic device to move between the user interface 714′ and the augmented user interface 714″.

It is understood that processes 800, 820 and 840 are examples and that more, fewer, or different operations can be performed in the same or in a different order. Additionally, the operations in processes 800, 820 and 840 described above are, optionally, implemented by running one or more functional modules in an information processing apparatus such as general-purpose processors (e.g., as described with respect to FIG. 2) or application specific chips, and/or by other components of FIG. 2.

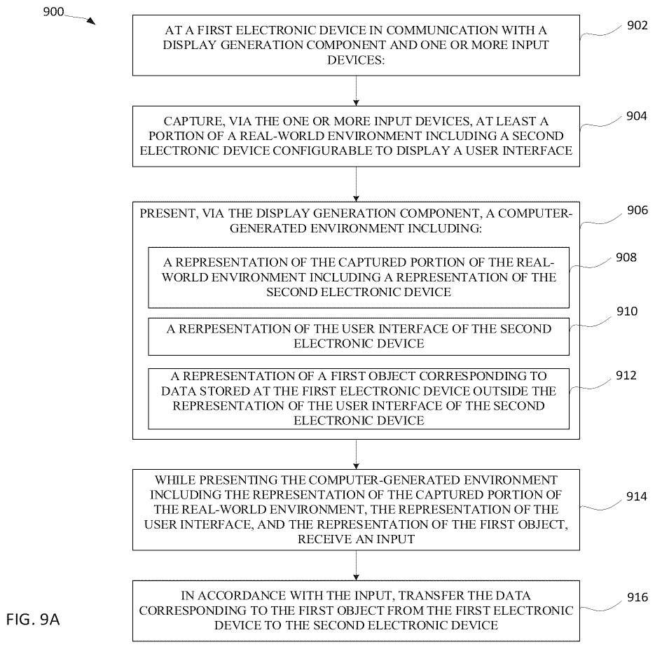

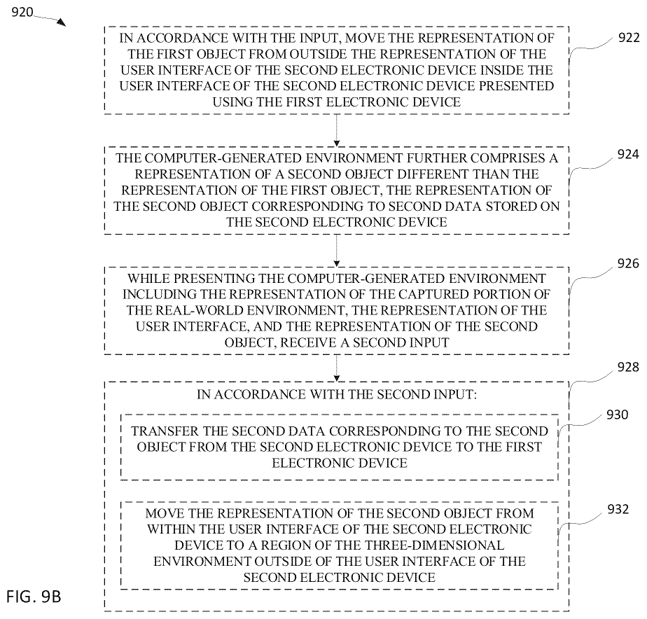

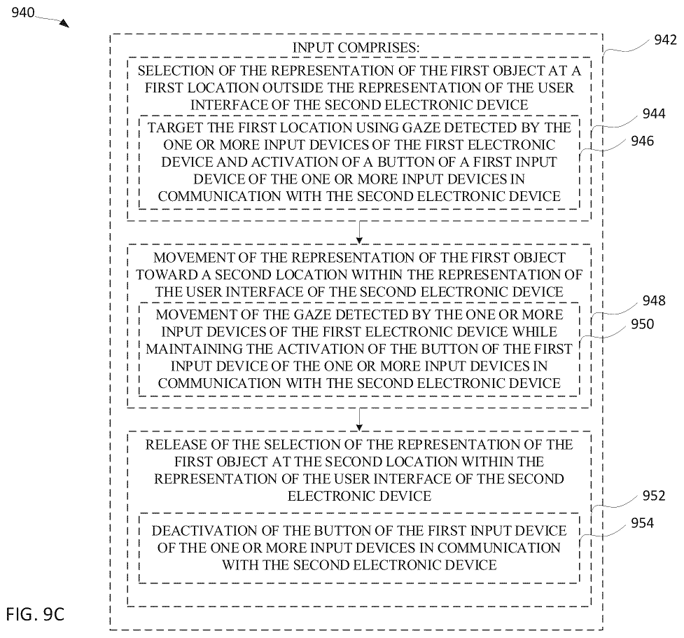

FIGS. 9A-9C illustrate flow diagrams illustrating example processes for moving an object between an augmented device corresponding to a first electronic device and an application window running on a second electronic device according to embodiments of the disclosure. As shown in FIG. 9A, process 900 begins at a first electronic device in communication with a display generation component and one or more input devices. In some embodiments, the first electronic device is optionally a head-mounted display similar or corresponding to device 240 of FIG. 2. As shown at 904, the first electronic device may capture, via the one or more input devices, at least a portion of a real-world environment including a second electronic device configurable to display a user interface. In some embodiments, the second electronic device may be a laptop computer, a desktop computer, or a tablet computer, among other possibilities, similar or corresponding to device 230 of FIG. 2. Additionally, in some embodiments, the second electronic device is optionally configurable to display a user interface comprising one or more user interface elements and/or one or more objects, such as user interface 315/315′ of FIGS. 4A-4D, for example.

At 906, the first electronic device may present, via the display generation component, a computer-generated environment. In some embodiments, the computer-generated environment optionally includes a representation of the captured portion of the real-world environment including a representation of the second electronic device (908), a representation of the user interface of the second electronic device (910), and a representation of a first object corresponding to data stored at the first electronic device outside the representation of the user interface of the second electronic device (912). For example, the first electronic device may present a three-dimensional environment (e.g., three-dimensional environment 455 of FIG. 4A) including a three-dimensional representation of the second electronic device (e.g., 415′), the augmented user interface (e.g., 414″ in FIG. 4A) of the augmented device (e.g., 445 in FIG. 4A), and a representation of a file (e.g., second file 462) corresponding to data stored in memory on the first electronic device. At 914, while presenting the computer-generated environment including the representation of the captured portion of the real-world environment, the representation of the user interface, and the representation of the first object, the first electronic device may receive an input. For example, the input may correspond to movement of the first object from a user interface of the first electronic device to the augmented user interface of the augmented device, as shown in FIGS. 4B-4C. In accordance with the input, at 916, the first electronic device may transfer data corresponding to the first object from the first electronic device to the second electronic device.

Additionally or alternatively, as shown by process 920 in FIG. 9B, in accordance with the input, the first electronic device may move the representation of the first object from outside the representation of the user interface of the second electronic device inside the user interface of the second electronic device presented using the first electronic device. For example, in some embodiments, the representation of the file may be displayed within the augmented user interface 414″ of the augmented device 445, as shown in FIG. 4D. Additionally or alternatively, in some embodiments, data can be transferred from the second electronic device to the first electronic device, as described with reference to FIGS. 6A-6D. As shown in FIG. 9B, at 924, the computer-generated environment further comprises a representation of a second object (e.g., third file 663 of FIG. 6A) different than the representation of the first object, the representation of the second object corresponding to second data stored on the second electronic device. At 926, while presenting the computer-generated environment including the representation of the captured portion of the real-world environment, the representation of the user interface, and the representation of the second object, the first electronic device may receive a second input. For example, the second input may correspond to movement of the second object from the augmented user interface of the augmented device to the user interface of the first electronic device, as shown in FIGS. 6B-6C. In accordance with the second input, at 928, the first electronic device may receive the second data corresponding to the second object from the second electronic device (930), and move the representation of the second object from within the user interface of the second electronic device to a region of the three-dimensional environment outside of the user interface of the second electronic device (932).

Additionally or alternatively, in some embodiments, the input corresponds to movement of the representation of the object. As shown by process 940 of FIG. 9C, the input comprises, at 942, selection of the representation of the first object at a first location outside the representation of the user interface of the second electronic device, at 944. In some embodiments, the selection of the representation optionally includes targeting the first location using gaze detected by the one or more input devices of the first electronic device and activation of a button of a first input device of the one or more input devices in communication with the second electronic device, at 944. At 948, the input may further comprise movement of the representation of the first object toward a second location within the representation of the user interface of the second electronic device. In some embodiments, the movement of the representation optionally includes movement of the gaze detected by the one or more input devices of the first electronic device while maintaining the activation of the button of the first input device of the one or more input devices in communication with the second electronic device, at 950. The input may further comprise, at 952, release of the selection of the representation of the first object at the second location within the representation of the user interface of the second electronic device. In some embodiments, at 954, the release of the selection of the representation optionally includes deactivation of the button of the first input device of the one or more input devices in communication with the second electronic device.

It is understood that processes 900, 920 and 940 are examples and that more, fewer, or different operations can be performed in the same or in a different order. Additionally, the operations in processes 900, 920 and 940 described above are, optionally, implemented by running one or more functional modules in an information processing apparatus such as general-purpose processors (e.g., as described with respect to FIG. 2) or application specific chips, and/or by other components of FIG. 2.

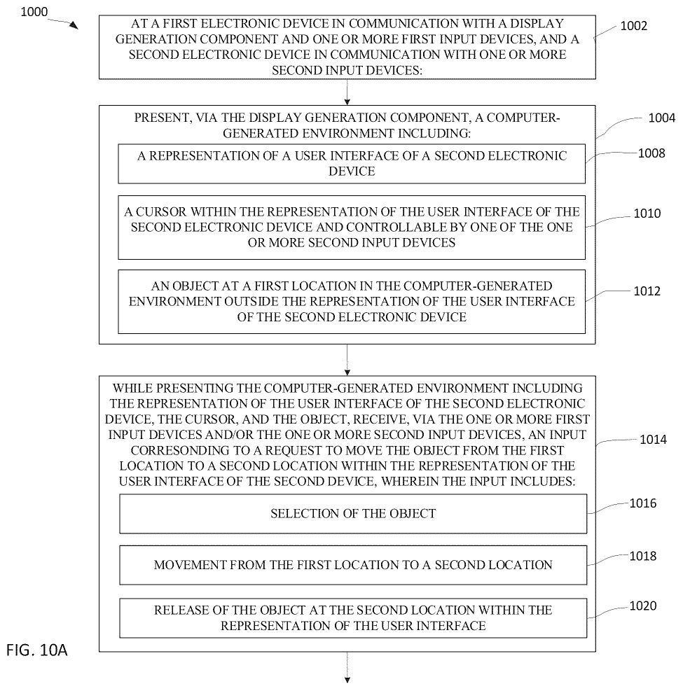

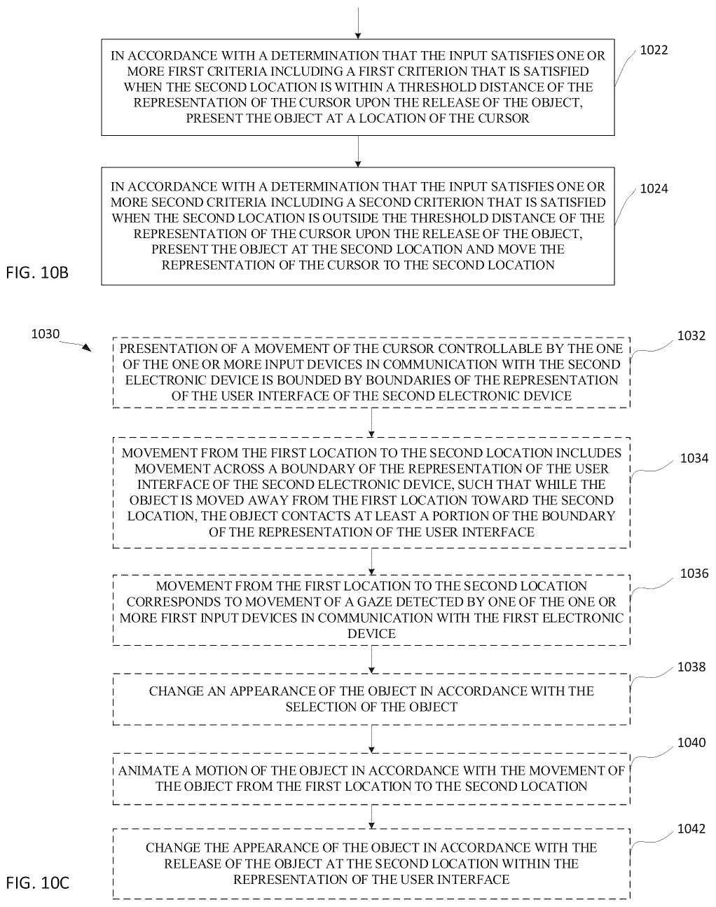

FIGS. 10A-10C illustrate flow diagrams illustrating example processes for altering a position of a cursor within an augmented device corresponding to a first electronic device while moving an object between the augmented device and an application window running on a second electronic device according to embodiments of the disclosure. As shown in FIG. 10A, process 1000 begins, at 1002, at a first electronic device in communication with a display generation component and one or more first input devices, and a second electronic device in communication with one or more second input devices. In some embodiments, the first electronic device is optionally a head-mounted display similar or corresponding to device 240 of FIG. 2. At 1004, the first electronic device may present, via the display generation component, a computer-generated environment. The computer-generated environment may include a representation of a user interface of a second electronic device (1008), a cursor within the representation of the user interface of the second electronic device and controllable by one of the one or more second input devices (1010), and an object at a first location in the computer-generated environment outside the representation of the user interface of the second electronic device (1012). For example, the first electronic device may display a three-dimensional environment (e.g., three-dimensional environment 555 of FIG. 5A) including an augmented user interface (e.g., augmented user interface 514″) of an augmented device (e.g., augmented device 545), a cursor (e.g., cursor 546) displayed within the augmented user interface, and an object (e.g., file 562) presented outside of the augmented user interface.

As shown at 1014, while presenting the computer-generated environment including the representation of the user interface of the second electronic device, the cursor, and the object, the first electronic device may receive, via the one or more first input devices and/or the one or more second input devices, an input corresponding to a request to move the object from the first location to a second location within the representation of the user interface of the second device. In some embodiments, the input optionally includes selection of the object (1016), movement from the first location to a second location (1018), and release of the object at the second location within the representation of the user interface (1020). For example, as described with reference to FIGS. 5A-5B, the input optionally corresponds to movement of the file 562 from the application window 548 to the user interface 514″ of the augmented device 545. As shown in FIG. 10B, at 1022, in accordance with a determination that the input satisfies one or more first criteria including a first criterion that is satisfied when the second location is within a threshold distance of the representation of the cursor upon the release of the object, the first electronic device can present the object at a location of the cursor. For example, as shown in FIG. 5C, if the user's gaze (at the second location) is within a threshold distance of a current location of the cursor 546 at the time of release, the file 562 is displayed at the current location of the cursor 546. At 1024, in accordance with a determination that the input satisfies one or more second criteria including a second criterion that is satisfied when the second location is outside the threshold distance of the representation of the cursor upon the release of the object, the first electronic device can present the object at the second location and move the representation of the cursor to the second location. For example, as shown in FIG. 5D, if the user's gaze (at the second location) is outside the threshold distance of the current location of the cursor 546 at the time of release, the file 562 and the cursor 546 are displayed at the current location of the gaze (the second location).

Additionally or alternatively, as shown by process 1030 in FIG. 10C, presentation of a movement of the cursor controllable by the one of the one or more input devices in communication with the second electronic device is bounded by boundaries of the representation of the user interface of the second electronic device, at 1032. Additionally or alternatively, at 1034, movement from the first location to the second location includes movement across a boundary of the representation of the user interface of the second electronic device, such that while the object is moved away from the first location toward the second location, the object contacts at least a portion of the boundary of the representation of the user interface. Additionally or alternatively, at 1036, movement from the first location to the second location corresponds to movement of a gaze detected by one of the one or more first input devices in communication with the first electronic device. In some embodiments, the first electronic device may present a shadow representation (e.g., shadow representation 562A) during the input moving the object from the first location to the second location. In some such embodiments, at 1038, the first electronic device may change an appearance of the object in accordance with the selection of the object. At 1040, the first electronic device may animate a motion of the object in accordance with the movement of the object from the first location to the second location. At 1042, the first electronic device may change the appearance of the object in accordance with the release of the object at the second location within the representation of the user interface of the second electronic device.

It is understood that processes 1000 and 1030 are examples and that more, fewer, or different operations can be performed in the same or in a different order. Additionally, the operations in processes 1000 and 1030 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some embodiments of the disclosure are directed to a method of launching an augmented user interface of an electronic device. The method can comprise: at a first electronic device in communication with a display and one or more input devices: capturing, via the one or more input devices, at least a portion of a real-world environment including a second electronic device with a display configured to display a first representation of a user interface of the second electronic device; presenting, via the display, a computer-generated environment including a representation of the captured portion of the real-world environment; while presenting the computer-generated environment including the representation of the captured portion of the real-world environment, in accordance with a determination that one or more first criteria are satisfied: presenting, via the display generation component, a first affordance associated with a representation of the second electronic device; while presenting the computer-generated environment including the representation of the captured portion of the real-world environment and the first affordance, receiving, via the one or more input devices, an input corresponding to a selection of the first affordance; and presenting, in the computer-generated environment, a second representation of the user interface of the second electronic device different than the first representation of the user interface, in accordance with the input corresponding to the selection of the first affordance.

Additionally or alternatively, in some embodiments, the first electronic device may be a head-mounted display.

Additionally or alternatively, in some embodiments, the second electronic device may be a laptop computer, a desktop computer, or a tablet computer.

Additionally or alternatively, in some embodiments, the one or more first criteria may include a criterion that is satisfied when the display of the second electronic device is visible to a user of the first electronic device.

Additionally or alternatively, in some embodiments, the one or more first criteria may include a criterion that is satisfied when the second electronic device is in communication with the first electronic device.

Additionally or alternatively, in some embodiments, the method may further comprise: while presenting, in the computer-generated environment, the second representation of the user interface of the second electronic device, presenting, via the display, a second affordance; in accordance with an input corresponding to a selection of the second affordance, ceasing presenting, in the computer-generated environment, the second representation of the user interface of the second electronic device.

Additionally or alternatively, in some embodiments, the method may further comprise while presenting, in the computer-generated environment, the second representation of the user interface of the second electronic device, causing the display of the second electronic device to power down.

Additionally or alternatively, in some embodiments, presenting, in the computer-generated environment, the second representation of the user interface of the second electronic device may include presenting, within the second representation of the user interface of the second electronic device, a cursor controllable by one or more input devices in communication with the second electronic device. Additionally or alternatively, in some embodiments, presentation of a movement of the cursor may be bounded within the second representation of the user interface of the second electronic device.

Additionally or alternatively, in some embodiments, the method can further comprise: while presenting, in the computer-generated environment, the second representation of the user interface of the second electronic device, receiving an input corresponding to a manipulation of contents of the second representation of the user interface of the second electronic device; and in accordance with the input corresponding to the manipulation of the representation of the user interface, updating an appearance of the second representation of the user interface in accordance with the input.

Additionally or alternatively, in some embodiments, presenting, in the computer-generated environment, the second representation of the user interface of the second electronic device can also include: presenting, in the computer-generated environment, a first portion of the first representation of the user interface of the second electronic device at a region of the computer-generated environment at which the display is located and a second portion of the first representation of the user interface in a user interface element within a threshold distance of the region of the computer-generated environment at which the display is located.

Additionally or alternatively, in some embodiments, the second representation of the user interface of the second electronic device may include a cursor controllable by one or more input devices in communication with the second electronic device. Additionally or alternatively, presentation of a movement of the cursor may be bounded by the region of the computer-generated environment at which the display is located and the user interface element within the threshold distance of the region of the computer-generated environment at which the display is located.

Additionally or alternatively, in some embodiments, the second representation of the user interface of the second electronic device may include one or more representations of portions of the first user interface displayed on the display of the second electronic device. Additionally or alternatively, in some embodiments, a size of the second representation of the user interface of the second electronic device in the computer-generated environment may be larger than a size of the display of the second electronic device.

Some embodiments of the disclosure are directed to a method of launching an augmented user interface of an electronic device. The method can comprise, at a first electronic device in communication with a display and one or more input devices, capturing, via the one or more input devices, at least a portion of a real-world environment including a second electronic device with a display configured to display a representation of a user interface of the second electronic device. Additionally or alternatively, in some embodiments, the display of the second electronic device may not be captured or the representation of the user interface of the second electronic device may not be captured. The method can further comprise: presenting, via the display, a computer-generated environment including a representation of the captured portion of the real-world environment; while presenting the computer-generated environment including the representation of the captured portion of the real-world environment, in accordance with a determination that one or more first criteria are satisfied: presenting, via the display, a first affordance associated with a representation of the second electronic device; while presenting the computer-generated environment including the representation of the captured portion of the real-world environment and the first affordance, receiving, via the one or more input devices, an input corresponding to a selection of the first affordance; and presenting, in the computer-generated environment, the representation of a user interface of the second electronic device.

Some embodiments of the disclosure are directed to a method of transferring data between a first electronic device and a second electronic device. The method can comprise: at a first electronic device in communication with a display and one or more input devices: capturing, via the one or more input devices, at least a portion of a real-world environment including a second electronic device configurable to display a user interface; presenting, via the display, a computer-generated environment including: a representation of the captured portion of the real-world environment including a representation of the second electronic device; a representation of the user interface of the second electronic device; and a representation of a first object corresponding to data stored at the first electronic device outside the representation of the user interface of the second electronic device; while presenting the computer-generated environment including the representation of the captured portion of the real-world environment, the representation of the user interface, and the representation of the first object, receiving an input; and in accordance with the input, transferring the data corresponding to the first object from the first electronic device to the second electronic device.

Additionally or alternatively, in some embodiments, the method can further comprise, in accordance with the input, moving the representation of the first object from outside the representation of the user interface of the second electronic device inside the user interface of the second electronic device presented using the first electronic device.

Additionally or alternatively, in some embodiments, the first electronic device may be a head-mounted display.

Additionally or alternatively, in some embodiments, the second electronic device may be a laptop computer, a desktop computer, or a tablet computer.

Additionally or alternatively, in some embodiments, the object may be a file.

Additionally or alternatively, in some embodiments, the input can comprise: selection of the representation of the first object at a first location outside the representation of the user interface of the second electronic device; movement of the representation of the first object toward a second location within the representation of the user interface of the second electronic device; and release of the selection of the representation of the first object at the second location within the representation of the user interface of the second electronic device.

Additionally or alternatively, in some embodiments, the computer-generated environment may further include a cursor controllable by one or more input devices in communication with the second electronic device. Additionally or alternatively, in some embodiments, the selection of the representation of the first object at the first location outside the representation of the user interface of the second electronic device can comprise targeting the first location using the cursor and activation of a button of a first input device of the one or more input devices in communication with the second electronic device. Additionally or alternatively, in some embodiments, the movement of the representation of the first object toward the second location within the representation of the user interface of the second electronic device can comprise movement of the cursor using the first input device while maintaining the activation of the button of the first input device. Additionally or alternatively, in some embodiments, the release of the selection of the representation of the first object at the second location within the representation of the user interface of the second electronic device can comprise deactivation of the button of the first input device.

Additionally or alternatively, in some embodiments, the computer-generated environment may further include a cursor controllable by a first input device of one or more input devices in communication with the second electronic device. Additionally or alternatively, in some embodiments, the selection of the representation of the first object at the first location outside the representation of the user interface of the second electronic device can comprise targeting the first location using the cursor and activation of a first combination of keys of a second input device of the one or more input devices in communication with the second electronic device. Additionally or alternatively, in some embodiments, the movement of the representation of the first object to the second location within the representation of the user interface of the second electronic device can comprise movement of the cursor using the first input device from the first location to the second location. Additionally or alternatively, in some embodiments, the release of the selection of the representation of the first object at the second location within the representation of the user interface of the second electronic device can comprise activation of a second combination of keys, different than the first combination of keys, of the second input device.

Additionally or alternatively, in some embodiments, the selection of the representation of the first object at the first location outside the representation of the user interface of the second electronic device can comprise targeting the first location using gaze detected by the one or more input devices of the first electronic device and activation of a button of a first input device of the one or more input devices in communication with the second electronic device. Additionally or alternatively, in some embodiments, the movement of the representation of the first object toward the second location within the representation of the user interface of the second electronic device can comprise movement of the gaze detected by the one or more input devices of the first electronic device while maintaining the activation of the button of the first input device of the one or more input devices in communication with the second electronic device. Additionally or alternatively, in some embodiments, the release of the selection of the representation of the first object at the second location within the representation of the user interface of the second electronic device can comprise deactivation of the button of the first input device of the one or more input devices in communication with the second electronic device.

Additionally or alternatively, in some embodiments, the computer-generated environment may further comprise a representation of a second object different than the representation of the first object, the representation of the second object corresponding to second data stored on the second electronic device.

Additionally or alternatively, in some embodiments, the method can further comprise: while presenting the computer-generated environment including the representation of the captured portion of the real-world environment, the representation of the user interface, and the representation of the second object, receiving a second input; and in accordance with the second input: transferring the second data corresponding to the second object from the second electronic device to the first electronic device; and moving the representation of the second object from within the user interface of the second electronic device to a region of the three-dimensional environment outside of the user interface of the second electronic device.

Additionally or alternatively, in some embodiments, moving the representation of the second object from within the user of the second electronic device to the region of the three-dimensional environment outside of the user interface of the second electronic device can comprise: moving the representation of the second object from within the user interface of the second electronic device to a user interface element located at the region of the three-dimensional environment outside of the user interface of the second electronic device. Additionally or alternatively, in some embodiments, the user interface element may be associated with an application running on the first electronic device.

Some embodiments of the disclosure are directed to a method of resetting a location of a cursor displayed in a user interface of an electronic device. The method can comprise: at a first electronic device in communication with a display, one or more first input devices, and a second electronic device in communication with one or more second input devices: presenting, via the display, a computer-generated environment including: a representation of a user interface of a second electronic device, a cursor within the representation of the user interface of the second electronic device and controllable by one of the one or more second input devices, and an object at a first location in the computer-generated environment outside the representation of the user interface of the second electronic device; while presenting the computer-generated environment including the representation of the user interface of the second electronic device, the cursor, and the object, receiving, via the one or more first input devices and/or the one or more second input devices, an input corresponding to a request to move the object from the first location to a second location within the representation of the user interface of the second electronic device. Additionally or alternatively, in some embodiments, the input may include selection of the object, movement from the first location to a second location, and release of the object at the second location within the representation of the user interface. The method can further comprise: in accordance with a determination that the input satisfies one or more first criteria including a first criterion that is satisfied when the second location is within a threshold distance of the representation of the cursor upon the release of the object, presenting the object at a location of the cursor, and in accordance with a determination that the input satisfies one or more second criteria including a second criterion that is a satisfied when the second location is outside the threshold distance of the representation of the cursor upon the release of the object, presenting the object at the second location and moving the representation of the cursor to the second location.

Additionally or alternatively, in some embodiments, the first electronic device may be a head-mounted display.

Additionally or alternatively, in some embodiments, the second electronic device may be a laptop computer, a desktop computer, or a tablet computer.

Additionally or alternatively, in some embodiments, the one of the one or more input devices of the second electronic device may be a trackpad or a mouse.

Additionally or alternatively, in some embodiments, presentation of a movement of the cursor controllable by the one of the one or more input devices in communication with the second electronic device may be bounded by boundaries of the representation of the user interface of the second electronic device.

Additionally or alternatively, in some embodiments, the object may be presented in the computer-generated environment within a user interface element associated with an application running on the first electronic device.

Additionally or alternatively, in some embodiments, movement from the first location to the second location can include: movement across a boundary of the representation of the user interface of the second electronic device, such that while the object is moved away from the first location toward the second location, the object contacts at least a portion of the boundary of the representation of the user interface.

Additionally or alternatively, in some embodiments, movement from the first location to the second location can correspond to movement of a gaze detected by one of the one or more first input devices in communication with the first electronic device.

Additionally or alternatively, in some embodiments, the method can further comprise: changing an appearance of the object in accordance with the selection of the object; animating a motion of the object in accordance with the movement of the object from the first location to the second location; and changing the appearance of the object in accordance with the release of the object at the second location within the representation of the user interface.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at a first electronic device in communication with a display and one or more input devices:
capturing, via the one or more input devices, at least a portion of a real-world environment including a second electronic device with a display configured to display a first representation of a user interface of the second electronic device;
presenting, via the display, a computer-generated environment including a representation of the captured portion of the real-world environment;
while presenting the computer-generated environment including the representation of the captured portion of the real-world environment, in accordance with a determination that one or more first criteria are satisfied:
presenting, via the display, a first affordance associated with a representation of the second electronic device;
while presenting the computer-generated environment including the representation of the captured portion of the real-world environment and the first affordance, receiving, via the one or more input devices, an input corresponding to a selection of the first affordance; and
presenting, in the computer-generated environment, a second representation of the user interface of the second electronic device different than the first representation of the user interface, in accordance with the input corresponding to the selection of the first affordance.

2. The method of claim 1, wherein the one or more first criteria include a criterion that is satisfied when the display of the second electronic device is visible to a user of the first electronic device.

3. The method of claim 1, wherein the one or more first criteria include:
a criterion that is satisfied when the second electronic device is in communication with the first electronic device.

4. The method of claim 1, further comprising:
while presenting, in the computer-generated environment, the second representation of the user interface of the second electronic device, causing the display of the second electronic device to power down.

5. The method of claim 1, wherein presenting, in the computer-generated environment, the second representation of the user interface of the second electronic device includes:
presenting, within the second representation of the user interface of the second electronic device, a cursor controllable by one or more input devices in communication with the second electronic device;
wherein presentation of a movement of the cursor is bounded within the second representation of the user interface of the second electronic device.

6. The method of claim 1, further comprising:
while presenting, in the computer-generated environment, the second representation of the user interface of the second electronic device, receiving an input corresponding to a manipulation of contents of the second representation of the user interface of the second electronic device; and
in accordance with the input corresponding to the manipulation of the representation of the user interface, updating an appearance of the second representation of the user interface in accordance with the input.

7. The method of claim 1, wherein presenting, in the computer-generated environment, the second representation of the user interface of the second electronic device also includes:
presenting, in the computer-generated environment, a first portion of the first representation of the user interface of the second electronic device at a region of the computer-generated environment at which the display is located and a second portion of the first representation of the user interface in a user interface element within a threshold distance of the region of the computer-generated environment at which the display is located.

8. The method of claim 7, wherein the second representation of the user interface of the second electronic device includes a cursor controllable by one or more input devices in communication with the second electronic device;
wherein presentation of a movement of the cursor is bounded by the region of the computer-generated environment at which the display is located and the user interface element within the threshold distance of the region of the computer-generated environment at which the display is located.

9. A first electronic device comprising:
one or more processors;
memory; and
one or more programs stored in the memory and configured to be executed by the one or more processors, the one or more programs including instructions for performing a method comprising:
capturing, via one or more input devices, at least a portion of a real-world environment including a second electronic device with a display configured to display a first representation of a user interface of the second electronic device;
presenting, via a display, a computer-generated environment including a representation of the captured portion of the real-world environment;
while presenting the computer-generated environment including the representation of the captured portion of the real-world environment, in accordance with a determination that one or more first criteria are satisfied:
presenting, via the display, a first affordance associated with a representation of the second electronic device;
while presenting the computer-generated environment including the representation of the captured portion of the real-world environment and the first affordance, receiving, via the one or more input devices, an input corresponding to a selection of the first affordance; and
presenting, in the computer-generated environment, a second representation of the user interface of the second electronic device different than the first representation of the user interface, in accordance with the input corresponding to the selection of the first affordance.

10. The first electronic device of claim 9, wherein the one or more first criteria include a criterion that is satisfied when the display of the second electronic device is visible to a user of the first electronic device.

11. The first electronic device of claim 9, wherein the one or more first criteria include:
a criterion that is satisfied when the second electronic device is in communication with the first electronic device.

12. The first electronic device of claim 9, wherein the method further comprises:
while presenting, in the computer-generated environment, the second representation of the user interface of the second electronic device, causing the display of the second electronic device to power down.

13. The first electronic device of claim 9, wherein presenting, in the computer-generated environment, the second representation of the user interface of the second electronic device includes:
presenting, within the second representation of the user interface of the second electronic device, a cursor controllable by one or more input devices in communication with the second electronic device;
wherein presentation of a movement of the cursor is bounded within the second representation of the user interface of the second electronic device.

14. The first electronic device of claim 9, wherein the method further comprises:
while presenting, in the computer-generated environment, the second representation of the user interface of the second electronic device, receiving an input corresponding to a manipulation of contents of the second representation of the user interface of the second electronic device; and
in accordance with the input corresponding to the manipulation of the representation of the user interface, updating an appearance of the second representation of the user interface in accordance with the input.

15. The first electronic device of claim 9, wherein presenting, in the computer-generated environment, the second representation of the user interface of the second electronic device also includes:
presenting, in the computer-generated environment, a first portion of the first representation of the user interface of the second electronic device at a region of the computer-generated environment at which the display is located and a second portion of the first representation of the user interface in a user interface element within a threshold distance of the region of the computer-generated environment at which the display is located.

16. The first electronic device of claim 15, wherein the second representation of the user interface of the second electronic device includes a cursor controllable by one or more input devices in communication with the second electronic device;
wherein presentation of a movement of the cursor is bounded by the region of the computer-generated environment at which the display is located and the user interface element within the threshold distance of the region of the computer-generated environment at which the display is located.

17. A non-transitory computer readable storage medium storing one or more programs, the one or more programs comprising instructions, which when executed by one or more processors of a first electronic device, cause the first electronic device to perform a method comprising:
capturing, via one or more input devices, at least a portion of a real-world environment including a second electronic device with a display configured to display a first representation of a user interface of the second electronic device;
presenting, via a display, a computer-generated environment including a representation of the captured portion of the real-world environment;
while presenting the computer-generated environment including the representation of the captured portion of the real-world environment, in accordance with a determination that one or more first criteria are satisfied:
presenting, via the display, a first affordance associated with a representation of the second electronic device;
while presenting the computer-generated environment including the representation of the captured portion of the real-world environment and the first affordance, receiving, via the one or more input devices, an input corresponding to a selection of the first affordance; and
presenting, in the computer-generated environment, a second representation of the user interface of the second electronic device different than the first representation of the user interface, in accordance with the input corresponding to the selection of the first affordance.

18. The non-transitory computer readable storage medium of claim 17, wherein the one or more first criteria include a criterion that is satisfied when the display of the second electronic device is visible to a user of the first electronic device.

19. The non-transitory computer readable storage medium of claim 17, wherein the one or more first criteria include:
a criterion that is satisfied when the second electronic device is in communication with the first electronic device.

20. The non-transitory computer readable storage medium of claim 17, wherein the method further comprises:
while presenting, in the computer-generated environment, the second representation of the user interface of the second electronic device, causing the display of the second electronic device to power down.

21. The non-transitory computer readable storage medium of claim 17, wherein presenting, in the computer-generated environment, the second representation of the user interface of the second electronic device includes:
presenting, within the second representation of the user interface of the second electronic device, a cursor controllable by one or more input devices in communication with the second electronic device;
wherein presentation of a movement of the cursor is bounded within the second representation of the user interface of the second electronic device.

22. The non-transitory computer readable storage medium of claim 17, wherein the method further comprises:
while presenting, in the computer-generated environment, the second representation of the user interface of the second electronic device, receiving an input corresponding to a manipulation of contents of the second representation of the user interface of the second electronic device; and
in accordance with the input corresponding to the manipulation of the representation of the user interface, updating an appearance of the second representation of the user interface in accordance with the input.

23. The non-transitory computer readable storage medium of claim 17, wherein presenting, in the computer-generated environment, the second representation of the user interface of the second electronic device also includes:
presenting, in the computer-generated environment, a first portion of the first representation of the user interface of the second electronic device at a region of the computer-generated environment at which the display is located and a second portion of the first representation of the user interface in a user interface element within a threshold distance of the region of the computer-generated environment at which the display is located.

24. The non-transitory computer readable storage medium of claim 23, wherein the second representation of the user interface of the second electronic device includes a cursor controllable by one or more input devices in communication with the second electronic device;
wherein presentation of a movement of the cursor is bounded by the region of the computer-generated environment at which the display is located and the user interface element within the threshold distance of the region of the computer-generated environment at which the display is located.
